(19) United States
(12) Patent Application Publication
(10) Pub. No.: US 2026/0184856 A1
(43) Pub. Date: Jul. 2, 2026

(54) COMPATIBILIZATION OF POLYMER BLENDS BY MIXED-GRAFT BLOCK COPOLYMERS

(71) Applicant: Yale University, New Haven, CT (US)

(72) Inventors: Mingjiang Zhong, Stamford, CT (US); Mengxue Cao, Dorchester, MA (US)

(21) Appl. No.: 19/130,701

(22) PCT Filed: Nov. 20, 2023
(86) PCT No.: PCT/US23/80461

§ 371 Date: May 16, 2025

Related U.S. Application Data
(60) Provisional application No. 63/428,587, filed on Nov. 29, 2022.

(51) Int. Cl. C08G 81/02; C08F 8/30

(52) U.S. Cl. CPC C08G 81/021; C08F 8/30; C08F 2438/01

(57) ABSTRACT

A mixed-graft block copolymer (mGBCP) compatibilizer for use in mixed waste plastic recycle streams. The mixed-graft block copolymer compatibilizer is capable of producing compatibilized blends that exhibit competitive mechanical properties as compared with virgin plastic products. The mGBCP contains a linear backbone that is tethered to two or more dissimilar side chains. The two or more dissimilar side chains undergo phase separation in a polymer blend, with each side chain interacting with its corresponding homopolymer by polymer chain entanglement or co-crystallization.

### STATEMENT REGARDING FEDERALLY SPONSORED RESEARCH OR DEVELOPMENT

This invention was made with Government support under DMR-2003875, awarded by the National Science Foundation. The U.S. Government has certain rights in the invention.

### FIELD

The present invention relates generally to the compatibilization of polymer blends, including blends of mixed plastic wastes by the use of mixed-graft block copolymers.

### BACKGROUND

Polymer blending serves as a convenient and cost-effective strategy to design new materials with combined or enhanced properties compared to their original components. Polymer blend-based materials have been used for automotive, electronics, and consumer goods, occupying a large portion of current plastic market.

Polyolefins (e.g., high-density polyethylene (HDPE), low-density polyethylene (LDPE), isotactic polypropylene (iPP) and polystyrene (PS) are predominant products of the plastic market. These materials are often used in packaging, which occupies around 30% of the total U.S. annual waste, with a limited recycling rate up to 9%. These naturally non-degradable polymers, derived from non-renewable fossil resources, introduce environmental concerns associated with sustainability. Therefore, finding an efficient and economic pathway for recycling these materials is urgently needed. Mechanical recycling (e.g., melt extrusion), facilitated by the addition of polymer-based compatibilizers, would open a door to the direct reuse of the mixed plastic waste stream.

Although these polymers are composed predominately of carbon and hydrogen atoms, their properties are varied from the high ductility and toughness of high-density polyethylene to the high modulus yet brittleness of polystyrene. Macrophase separation can take place even between high-density polyethylene and isotactic polypropylene with nearly identical molecular formulas.

Compatibilizers have long been used as a tool in the industry to create special resin or polymer blends that yield desired performance and properties that could only be obtained by a co-polymer blend of resins that would otherwise not be compatible.

The use of compatibilizers has been suggested as a possible solution in the recycling industry as a way to create value in mixed plastic feed streams that cannot be further segregated by resin type, either due to technical challenges related to collecting, cleaning, and sorting of the mixed plastic feed streams or due to economic infeasibility.

Current plastics recycling strategies require either high energy input or cost-intensive presorting, and result in inferior products. In mechanical recycling of plastic waste, the immiscibility of different polymers deteriorate the mechanical properties of their blends due to macrophase separation and the weak interfacial adhesion between different polymers.

The addition of compatibilizers to a mixture of dissimilar waste stream plastics has been suggested as a way of upgrading the end-of-use of such plastics that are typically collected in a form of a mixture given the cost-intensive and societally-impractical sorting process. The macrophase separation driven by the thermodynamic immiscibility of the dissimilar polymers deteriorate the blends' mechanical properties due to the poor adhesion at phase interfaces. The mechanical properties of the blend can be enhanced by the addition of a compatibilizer that can “stitch” the interface of separated phases, improve interface adhesion, and stabilize the phase-separated morphology to enhance mechanical properties of the blend.

Compatibilizers, including premade copolymers and in-situ reactive compatibilization, are one solution for enhancing mechanical properties of the blends by improving the interfacial adhesion between different polymers in the blends.

Reactive blending involves the addition of catalysts or polymers with reactive groups that can generate graft/block copolymers or crosslinking in situ via efficient coupling reactions during the melt blending of dissimilar polymers. The copolymer formation and morphology evolution occurred simultaneously, and optimal processing conditions are critical to balancing the two processes and ensuring that the copolymers migrate to the interface after mixing.

Reactive compatibilization does not require tedious synthesis before blending. However, reactive compatibilization requires a high catalyst or polymer precursor loading and generates thermosetting recycled products that sacrifices their processability. In addition, a high loading of precursors or catalysts (typically in the range of 5-20 wt. %) is usually required to provide some margin for incomplete reactions and maximize the compatibilization performance. The metallic catalysts used in the reactive compatibilization as well as the resulting non-reprocessable thermosetting products negatively impact their value in plastic recycling. Furthermore, this simple but crude way of compatibilization impedes the further investigation of structure-property relationships of the compatibilizer.

An alternative compatibilization strategy is based on premade block copolymers (BCPs) and graft copolymers (GCPs) which have been utilized with a typical compatibilizer loading of 5-10 wt. %. These copolymers can migrate to the interfaces during blending and modify the properties of the interfaces like interfacial adhesives. The distinct segments of the copolymer segregate separately with their respectively favored homopolymers, an enthalpically-driven process that can be determined by the Flory-Huggins interaction parameters (X). The compatibilization is assisted by other physical interactions introduced by the addition of copolymers, such as chain entanglement as well as segment co-crystallization if applicable.

The molecular weight of the blocks or grafts has a pronounced impact on the compatibilization performance. BCPs with a higher molecular weight of the blocks tend to provide a higher degree of entanglement and crystallization with homopolymers, which is desirable for a more efficient compatibilization. Similarly, GCPs with longer graft chains, higher grafting numbers, and longer backbones usually exhibit better compatibilization performance. However, increasing molecular weight of the copolymers also leads to a lower diffusion coefficient and a reduced critical micellization concentration (CMC) above which further addition of the copolymer becomes ineffective. When reaching CMC, the additional copolymers will self-assemble into swollen micelles that distribute in one of the homopolymer phases instead of remaining at the interface.

Thus, the utilization of premade compatibilizers, i.e., block copolymers and graft copolymers, fails to replace traditional waste management options because of the high loading requirement of the compatibilizer and the costs for synthesis of the compatibilizers along with the need for high block lengths of the copolymers.

Therefore, new compatibilizers that can be synthesized with a universal synthetic methodology, a low loading in the blend, and a high efficiency are urgently needed for future plastic recycling. In addition, developing new compatibilizers with higher efficiency and lower loading is a key step towards the commercialization of the premade compatibilizers.

Recently, the superior performance of -(PE-h-iPP)- multiblock copolymers (MBCP) utilizing HDPE/iPP blends was reported. Enabled by the judicious design of a hafnium pyridylamine catalyst, tetrablock and hexablock copolymers with varied block lengths were synthesized and applied as compatibilizers. After adding only 1 wt. % of the tetrablock copolymer, the elongation at break of the blends increased by over 40 times relative to that of the pristine blends and 10 times at 1 wt. % of the diblock copolymer compatibilizer with a similar block length. Peel tests using MBCPs as adhesive layers between HDPE and iPP indicated that the dramatically improved mechanical properties of the blends benefited from the strong interfacial adhesion, which was attributed to an interlocked entanglement between compatibilizers and homopolymers at the interface of two phases. This trapped conformation enabled by the multiblock architecture facilitated the copolymer to efficiently adhere the two phases. Despite their intriguing interfacial behaviors, it was difficult to extend the synthesis of PE-iPP multiblock copolymers to other combination of polymers, such as PE-PS and PP-PS. Thus, the universalization of this compatibilization strategy to an expanded library of mixed plastics remains a challenge.

U.S. Pat. No. 10,961,338 to Johnson et al., the subject matter of which is herein incorporated by reference in its entirety, describes bottlebrush polymers and diblock bottlebrush polymers that can self-assemble into structures of desired morphology, which structures provide useful materials such as photonics, functional materials, chromatography media, stimuli-responsive materials, lubricants, nanolithography, films and coatings. However, there is no suggestion that such bottlebrush polymers may be used as compatibilizers for use in mixed plastic waste streams.

U.S. Pat. No. 9,822,216 to Mahanthappa et al., the subject matter of which is herein incorporated by reference in its entirety, describes microphase separated materials including a plurality of block copolymers tethered together at their A-B junction points. These materials are usable for various applications including electronics, photonics, and biological engineering. Again, there is no suggestion that such bottlebrush polymers may be used as compatibilizers for use in mixed plastic waste streams.

U.S. Pat. No. 11,279,780 to Coates et al., the subject matter of which is herein incorporated by reference in its entirety, describes semicrystalline multiblock copolymers including alternating blocks of semicrystalline isotactic polypropylene (iPP) and semicrystalline polyethylene (PE) having a block arrangement. However, this compatibilizer is only concerned with the compatibilization of isotactic polypropylene and semicrystalline polyethylene, and does not provide for universalized compatibilization of other types of polymers that may also be included in mixed plastic waste.

### SUMMARY

In one embodiment, the present invention relates generally to a method of compatibilizing mixed plastic waste to produce a polymer blend that exhibits improved mechanical properties, the method comprising:
a) adding from about 0.05 to about 5 wt. % of a mixed-graft block copolymer compatibilizer to a blend of dissimilar polymers, wherein the mixed-graft block copolymer compatibilizer comprises: a linear polymeric backbone tethered to two or more types of polymeric side chains, preferably wherein the two or more types of polymeric side chains are selected from the group consisting of polyethylene, polystyrene, isotactic polypropylene, atactic polypropylene, poly(methyl methacrylate), polyacrylate, polyacrylamide, polydimethylsiloxane, poly(lactic acid), poly(ethylene oxide), and polycaprolactone,
   wherein the frequency of the two or more types of polymeric side chains tethered along the linear polymeric backbone ranges from about every 10 to about every 200 carbon atoms along the linear polymeric backbone; and
b) mixing the blend of dissimilar polymers and the mixed-graft block copolymer compatibilizer utilizing melt processing at a temperature greater than the melting points or glass transition temperatures of the dissimilar polymers, or utilizing solution processing for at least 30 minutes, preferably at least 60 minutes, more preferably at least 120 minutes in the presence of a solvent at a temperature with the range of about 80 to about 150° C.;
   wherein the polymeric side chains undergo phase separation in the blend of dissimilar polymers,
   wherein each type of polymer side chain interacts with its corresponding homopolymer in the blend of dissimilar polymers by polymer chain entanglement and co-crystallization to produce a polymer blend exhibiting improved mechanical properties.

In another embodiment, the present invention also relates generally to a mixed-graft block copolymer compatibilizer for compatibilizing a blend of dissimilar polymers, wherein the mixed-graft block copolymer compatibilizer comprises:
a linear polymeric backbone tethered to two or more types of polymeric side chains, wherein the two or more types of polymeric side chains are selected from the group consisting of polyethylene, polystyrene, isotactic polypropylene, atactic polypropylene, poly(methyl methacrylate), polyacrylate, polyacrylamide, polydimethylsiloxane, poly(lactic acid), poly(ethylene oxide), and polycaprolactone,
wherein the frequency of the two or more types of polymeric side chains tethered along the linear backbone ranges from about every 10 to about every 200 carbon atoms along the linear backbone.

In still another embodiment, the present invention also relates generally to a method of making a mixed-graft block copolymer compatibilizer for compatibilizing a blend of dissimilar polymers, the method comprising the steps of:
a) synthesizing a linear polymeric backbone including alkyne functional groups, preferably wherein the linear polymeric backbone comprises an alkyne-functionalized polymethacrylate backbone;
b) synthesizing a first azido-functionalized polymeric side chain precursor;
c) synthesizing a second azido-functionalized polymeric side chain precursor, wherein the polymer in the second azido-functionalized polymeric side chain precursor is different from the polymer in the first azido functionalized polymeric side chain precursor;
d) optionally, synthesizing one or more additional azido-functionalized polymeric side chain precursors, each of which contains a polymer that is different from the polymer in any of other azido-functionalized polymeric side chain precursors; and
e) synthesizing the multi-graft block copolymer compatibilizer by reacting the linear polymeric backbone including alkyne functional groups with the first azido-functionalized polymeric side chain precursor, the second azido-functionalized polymeric side chain precursor and the optional one or more additional azido-functionalized polymeric side chain precursors in the presence of a catalyst at an elevated temperature, preferably wherein the temperature is between about 60 and about 100° C., more preferably between about 75 and about 90° C. to produce a mixed-graft block copolymer compatibilizer.

In yet another embodiment, the present invention relates generally to mixed-graft block copolymer compatibilizer for compatibilizing a blend of dissimilar polymers, wherein the mixed-graft block copolymer compatibilizer comprises:
a linear polymeric backbone tethered to two or more types of polymeric side chains, wherein the two or more types of polymeric side chains are selected from the group consisting of polyethylene, polystyrene, isotactic polypropylene, atactic polypropylene, poly(methyl methacrylate), polyacrylate, polyacrylamide, polydimethylsiloxane, poly(lactic acid), poly(ethylene oxide), and polycaprolactone,
wherein the frequency of the two or more types of polymeric side chains tethered along the linear backbone ranges from about every 10 to about every 200 carbon atoms along the linear backbone.

### BRIEF DESCRIPTION OF THE FIGURES

To assist those of ordinary skill in the relevant art in making and using the subject matter hereof, reference is made to the appended figures.

FIG. 1 depicts HDPE/PS blends compatibilized with mGBCPs in accordance with the present invention as compared with other compatibilizers.

FIG. 2 depicts a synthetic route of mGBCPs through Cu(I)-catalyzed azide-alkyne cycloaddition (CuAAC) of alkyne-functionalized polymethacrylate backbone and azido-functionalized polyethylene and polystyrene side chains in accordance with Example 1.

FIGS. 3(a) to 3(d) depict the mechanical properties of the HDPE/PS/mGBCP blends.

FIGS. 4(a)-(d) depicts SEM images and droplet size analysis results of HDPE/PS/mGBCP2 70/30/w blends.

FIG. 5 depicts the influence of the blending and addition of mGBCPs on the polymer crystallinity

FIG. 6 depicts Young's modulus vs elongation at break of HDPE, PS, and their blends.

FIG. 7 depicts a ¹H NMR spectrum of TMS-backbone1 in CDCl₃.

FIG. 8 depicts a ¹H NMR spectrum of TMS-backbone2 in CDCl₃.

FIG. 9 depicts a ¹H NMR spectrum of TMS-backbone3 in CDCl₃.

FIG. 10 shows the ¹H NMR spectrum of OH-backbone1 in CDCl₃.

FIG. 11 shows the ¹H NMR spectrum of OH-backbone2 in CDCl₃.

FIG. 12 shows the ¹H NMR spectrum of OH-backbone3 in CDCl₃.

FIG. 13 depicts GPC traces of alkyne-containing backbones (THF as eluent).

FIG. 14 depicts a ¹H NMR spectrum of Backbone1 in CDCl₃.

FIG. 15 depicts a ¹H NMR spectrum of Backbone2 in CDCl₃.

FIG. 16 depicts a ¹H NMR spectrum of Backbone3 in CDCl₃.

FIG. 17 depicts a GPC trace of PS-Br-20k (THF as eluent).

FIG. 18 depicts an 1H NMR spectrum of PS-N₃-20k in CDCl₃.

FIG. 19 depicts a GPC trace of PS-N₃-20k (THF as eluent).

FIG. 20 depicts the XPS profile of the product of Example 6 and indicates a complete transformation from iodide to chloride.

FIG. 21 depicts an ¹H NMR spectrum of PE-OH-14k in toluene-d₈ at 85° C.

FIG. 22 depicts a ¹H NMR spectrum of PE-N₃-14k in toluene-d₈ at 85° C.

FIG. 23 depicts a ¹H NMR spectrum of 6-azidohexanoic acid in CDCl₃.

### DETAILED DESCRIPTION

The inventors of the present disclosure have developed a mixed-graft block copolymer (mGBCP) that is usable as a compatibilizer in mixed waste plastic streams and that is capable of producing compatibilized blends that exhibit competitive mechanical properties as compared with virgin plastic products. As described herein, the mGBCP contains a linear backbone that is tethered to two or more dissimilar side chains. The two or more dissimilar side chains undergo phase separation in a polymer blend, with each side chain interacting with its corresponding homopolymer by polymer chain entanglement or co-crystallization. The additive effect of side chains as well as the trapped entanglement between the homopolymers and the backbone of the mGBCPs acts to further strengthen the interfacial adhesion.

As used herein, “a,” “an,” and “the” refer to both singular and plural referents unless the context clearly dictates otherwise.

As used herein, the term “about” refers to a measurable value such as a parameter, an amount, a temporal duration, and the like and is meant to include variations of +/−15% or less, preferably variations of +/−10% or less, more preferably variations of +/−5% or less, even more preferably variations of +/−1% or less, and still more preferably variations of +/−0.1% or less of and from the particularly recited value, in so far as such variations are appropriate to perform in the invention described herein. Furthermore, it is also to be understood that the value to which the modifier “about” refers is itself specifically disclosed herein.

As used herein, the terms “comprises” and/or “comprising,” specify the presence of stated features, integers, steps, operations, elements, and/or components, but do not preclude the presence or addition of one or more other features, integers, steps, operations, elements, components, and/or groups thereof.

As used herein, the term “substantially free” or “essentially free” if not otherwise defined herein for a particular element or compound means that a given element or compound is not detectable by ordinary analytical means that are well known to those skilled in the art of metal plating for bath analysis. Such methods typically include atomic absorption spectrometry, titration, UV-Vis analysis, secondary ion mass spectrometry, and other commonly available analytically techniques.

All amounts are percent by weight unless otherwise noted. All numerical ranges are inclusive and combinable in any order except where it is logical that such numerical ranges are constrained to add up to 100%.

The terms “number average molecular weight,” “number average molar mass,” and “Mn” are measurements of the molecular mass of a polymer. The number average molecular mass is the ordinary arithmetic mean or average of the molecular masses of the individual polymers. It is determined by measuring the molecular mass of n polymer molecules, summing the masses, and dividing by n. For example, a polymer having 100 repeating units of a monomer with a molecular weight of 100 g/mol would have a number average molecular weight (Mn) of 10,000 Da [Mₙ=(100)*(100 Da)/(1)=10,000 Da)]. The number average molecular mass of a polymer can be determined by gel permeation chromatography, viscometry via the Mark-Houwink equation, colligative methods such as vapor pressure osmometry, end-group determination, or ¹H NMR.

When a range of values is listed, it is intended to encompass each value and sub-range within the range. For example, “C₁₋₆ alkyl” is intended to encompass, C₁, C₂, C₃, C₄, C₅, C₆, C₁₋₆, C₁₋₅, C₁₋₄, C₁₋₃, C₁₋₂, C₂₋₆, C₂₋₅, C₂₋₄, C₂₋₃, C₃₋₆, C₃₋₅, C₃₋₄, C₄₋₆, C₄₋₅, and C₅₋₆ alkyl.

The term “aliphatic” refers to alkyl, alkenyl, alkynyl, and carbocyclic groups. Likewise, the term “heteroaliphatic” refers to heteroalkyl, heteroalkenyl, heteroalkynyl, and heterocyclic groups.

The term “alkyl,” unless otherwise described in the specification as having substituent groups, refers to a radical of a straight-chain or branched saturated hydrocarbon group having a general formula: CₙH₍₂ₙ₊₁₎. Unless otherwise specified, each instance of an alkyl group is independently unsubstituted (an “unsubstituted alkyl”) or substituted (a “substituted alkyl”) with one or more substituents (e.g., halogen, such as F). In certain embodiments, the alkyl group is an unsubstituted C₁₋₁₀ alkyl, In certain embodiments, the alkyl group is a substituted C₁₋₁₀ alkyl.

The term “haloalkyl” is a substituted alkyl group, wherein one or more of the hydrogen atoms are independently replaced by a halogen, e.g., fluoro, bromo, chloro, or iodo. Examples of haloalkyl groups include —CF₃, —CF₂CF₃, —CF₂CF₂CF₃, —CCl₃, —CFCl₂, —CF₂Cl, and the like.

The term “alkyne” refers to a radical of a straight-chain or branched hydrocarbon group containing one or more carbon-carbon triple bonds. In certain embodiments, the alkyne is an unsubstituted C₂₋₁₀ alkyne. In certain embodiments, the alkyne is a substituted C₂₋₁₀ alkyne.

The term “polymer” refers to a molecule including two or more (e.g., 3 or more, 4 or more, 5 or more, 10 or more) repeating units which are covalently bound together. In certain embodiments, a polymer comprises 3 or more, 5 or more, 10 or more, 50 or more, 100 or more, 1000 or more, 2000 or more, or 4000 or more repeating units. In certain embodiments, a polymer comprises more than 4000 repeating units. The repeating units of a polymer are referred to as “monomers.” A “homopolymer” is a polymer that consists of a single repeating monomer. A “copolymer” is a polymer that comprises two or more different monomer subunits. Copolymers include, but are not limited to, random, block, alternating, segmented, linear, branched, grafted, and tapered copolymers. Polymers may be natural (e.g., naturally occurring polypeptides), or synthetic (e.g., non-naturally occurring). A polymer may have an overall molecular weight of 50 Da or greater, 100 Da or greater, 500 Da or greater, 1000 Da or greater, 2000 Da or greater, 5000 Da or greater, 10000 Da or greater, 20000 Da or greater, or 50000 Da or greater.

“Block copolymers” refer to copolymers comprising homopolymer subunits (i.e., “blocks”) covalently linked together. The blocks of a block copolymer are separated into distinct domains. Each distinct homopolymer domain of a block copolymer is of a different polymeric composition (e.g., comprising different repeating monomers).

The term “average” is equivalent to the mean value of a sample.

In one embodiment, the present invention relates generally to a method of compatibilizing mixed plastic waste to produce a polymer blend that exhibits improved mechanical properties, the method comprising:
a) adding from about 0.05 to about 5 wt. % of a mixed-graft block copolymer compatibilizer to a blend of dissimilar polymers, wherein the mixed-graft block copolymer compatibilizer comprises a linear polymeric backbone tethered to two or more types of polymeric side chains, preferably wherein the polymeric side chains are selected from the group consisting of polyethylene, polystyrene, isotactic polypropylene, atactic polypropylene, poly(methyl methacrylate), polyacrylate, polyacrylamide, polydimethylsiloxane, poly(lactic acid), poly(ethylene oxide), and polycaprolactone,
wherein the frequency of the two or more types of polymeric side chains tethered along the linear polymeric backbone ranges from about every 10 to about every 200 carbon atoms, or from about every 20 to about every 175 carbon atoms, or from about every 30 to about every 150 carbon atoms, or from about every 40 to about every 125 carbon atoms, or from about every 50 to about every 100 carbon atoms along the linear polymeric backbone; and
b) mixing the blend of dissimilar polymers and the mixed-graft block copolymer compatibilizer utilizing melt processing at a temperature greater than the melting points or glass transition temperatures of the dissimilar polymers, or utilizing solution processing for at least 30 minutes, preferably at least 60 minutes, more preferably at least 120 minutes in the presence of a solvent and at a temperature with the range of about 80 to about 150° C. or within the range of about 90 to about 140° C., or within the range of about 100 to about 130° C., or within the range of about 110 to about 120° C.;
wherein the polymeric side chains undergo phase separation in the blend of dissimilar polymers,
wherein each type of polymer side chain interacts with its corresponding homopolymer in the blend of dissimilar polymers by polymer chain entanglement and co-crystallization to produce a polymer blend exhibiting improved mechanical properties.

In one embodiment, the blend of dissimilar polymers comprise two or more of polyolefins (e.g., polypropylene and polyethylene), polystyrene, polar vinyl polymers (e.g., polyacrylate, polymethacrylate, and polyacrylamide), poly(lactic acid), poly(ethylene oxide), polycaprolactone, polydimethylsiloxane, or combinations thereof. For example, the blend of dissimilar polymers may comprise a blend of polypropylene and polyethylene, a blend or polystyrene and polyethylene, a blend of polystyrene and polypropylene, or a blend of polypropylene, polyethylene and polystyrene, by way of example and not limitation. That is, depending on the type of polymeric side chain tethered to the linear polymeric backbone, the blend of dissimilar polymers may include any type of a number of types of polymers that are typically found in a mixed plastic waste stream.

In one embodiment, two or more mixed-graft block copolymer compatibilizers are used together in the polymer blend and the two or more mixed-graft block copolymer compatibilizers are used for compatibilizing a blend of isotactic polypropylene and high density polyethylene; a blend of polystyrene and poly(methyl methacrylate); a blend of polystyrene and high density polyethylene; a blend of polystyrene and isotactic polypropylene; a blend of isotactic polypropylene, high density polyethylene and polystyrene; a blend of isotactic polypropylene, high density polyethylene and polydimethylsiloxane; a blend of isotactic polypropylene, high density polyethylene, polystyrene and polydimethylsiloxane; or combinations thereof. That is, each of the two or more mixed-graft copolymer compatibilizers includes at least two types of polymeric side chains and the combination of two or more polymeric side chains in each of the two or more mixed-graft block copolymers is different in at least one respect from the other of the two or more mixed-graft block copolymers. Thus, mixed use plastic wastes containing a variety of plastics can be compatibilized with the two or more mixed-graft copolymer compatibilizers.

Thus, it is contemplated that the mixed plastic waste may be compatibilized by adding either a mixed-graft block copolymer compatibilizer that contains a polymeric backbone tethered to two or three or four, etc. polymeric side chains or, alternatively by adding two or more mixed-graft block copolymer compatibilizers to the mixed plastic waste that are each different in one respect from the other.

In one embodiment, the solvent for mixing the blend of dissimilar polymers and the compatibilizer described herein may be selected from the group consisting of xylene, dichlorobenzene, trichlorobenzene, dimethylformamide, toluene, anisole, and benzene. In one preferred embodiment, the solvent comprises xylene.

In one embodiment, the concentration of the one or more mixed-graft block copolymer compatibilizers in the blend of dissimilar polymers is in the range of about 0.05 to about 5.0 wt. %, more preferably in the range of about 0.1 to about 3 wt. %, and still more preferably about 0.5 to about 1.0 wt. %.

In one embodiment, the present invention also relates generally to a mixed-graft block copolymer compatibilizer for compatibilizing a blend of dissimilar polymers, wherein the mixed-graft block copolymer compatibilizer comprises:
a linear polymeric backbone tethered to two or more types of polymeric side chains, wherein the two or more types of polymeric side chains may be selected from the group consisting of polyethylene, polystyrene, isotactic polypropylene, atactic polypropylene, poly(methyl methacrylate), polyacrylate, polyacrylamide, polydimethylsiloxane, poly(lactic acid), poly(ethylene oxide), and polycaprolactone,
wherein the frequency of the two or more types of polymeric side chains tethered along the linear backbone ranges from about every 10 to about every 200 carbon atoms, or from about every 20 to about every 175 carbon atoms, or from about every 30 to about every 150 carbon atoms, or from about every 40 to about every 125 carbon atoms, or from about every 50 to about every 100 carbon atoms along the linear backbone.

In one embodiment, the linear polymeric backbone has a molecular weight up to about 1,000,000 g/mol, more preferably in the range of about 20,000 to about 1,000,000 g/mol.

In one embodiment, the linear polymeric backbone is derived from an alkyne-functionalized backbone precursor, which alkyne-functionalized backbone precursor may be selected from the group consisting of polymethacrylate, polyacrylate, polystyrene, polyester, polynorbornene, polydimethylsiloxane, polyacrylamide and combinations thereof. In one preferred embodiment, the linear backbone comprises an alkyne-functionalized polymethacrylate.

In one embodiment, the alkyne-functionalized backbone precursor exhibits a polydispersity index in the range of about 1.1 to about 2.0. In one embodiment, the polydispersity index is less than about 2.0, more preferably the polydispersity index is less than about 1.5, and still more preferably the polydispersity index is less than about 1.3.

In one embodiment, the linear polymeric backbone precursor of the mixed-graft block copolymer compatibilizer comprises between about 10 and about 5,000 alkyne repeat units, preferably between about 300 and about 4,000 alkyne repeat units, and still more preferably between about 500 and about 3,000 alkyne repeat units.

As discussed above, in one embodiment, the linear backbone is tethered to two or more types of polymeric side chains, which may be selected from the group consisting of polyethylene, polystyrene, isotactic polypropylene, atactic polypropylene, poly(methyl methacrylate), polyacrylate, polyacrylamide, polydimethylsiloxane, poly(lactic acid), poly(ethylene oxide), and polycaprolactone. In one embodiment, the linear backbone is tethered to at least one of polyethylene and isotactic polypropylene. In one embodiment, the linear backbone is tethered to polyethylene and isotactic polypropylene. While isotactic polypropylene can be prepared in a variety of ways, in one embodiment isotactic polypropylene is prepared from a vinyl terminated isotactic polypropylene precursor. One example of a process for making a vinyl terminated isotactic polypropylene precursor can be found in U.S. Pat. No. 6,117,962 to Weng et al., the subject matter of which is herein incorporated by reference in its entirety.

In one embodiment, the mixed-graft block copolymer compatibilizer includes two polymeric side chains. In one embodiment, the ratio of the two polymeric side chains is in the range of 99:1 to 1:99, preferably in the range of 90:10 to 10:90, or alternatively in the range of 80:20 to 20:80, or still alternatively in the range of 30:70 to 70:30.

In one embodiment, the molecular weight of each of the polymeric side chains is in the range of about 1,000 to about 30,000 g/mol, preferably in the range of about 2,000 to about 25,000 g/mol, preferably in the range of about 5,000 to about 20,000 g/mol, or alternatively in the range of about 6,000 to about 10,000 g/mol, or still alternatively in the range of about 7,000 to about 9,000 g/mol.

In one embodiment, the mixed-graft block copolymer compatibilizer is configured for compatibilizing two or more dissimilar polymers in a blend of dissimilar polymers to produce a compatibilized polymer blend that exhibits improved mechanical properties. In another embodiment, the mixed-graft block copolymer compatibilizer is configured for compatibilizing three or more dissimilar polymers in a blend of dissimilar polymers to produce a compatibilized polymer blend exhibiting improved mechanical properties. In yet another embodiment, the mixed-graft block copolymer compatibilizer is configured for compatibilizing four or more dissimilar polymers in a blend of dissimilar polymers to produce a compatibilized polymer blend exhibiting improved mechanical properties.

In one embodiment, the present invention also relates generally to a method of making a mixed-graft block copolymer compatibilizer for compatibilizing a blend of dissimilar polymers, the method comprising the steps of:
a) synthesizing a linear polymeric backbone including alkyne functional groups, preferably wherein the linear polymeric backbone comprises an alkyne-functionalized polymethacrylate backbone;
b) synthesizing a first azido-functionalized polymeric side chain precursor;
c) synthesizing a second azido-functionalized polymeric side chain precursor, wherein the polymer in the second azido-functionalized polymeric side chain precursor is different from the polymer in the first azido functionalized polymeric side chain precursor;
d) optionally, synthesizing one or more additional azido-functionalized polymeric side chain precursors, each of which contains a polymer that is different from the polymer in any of other azido-functionalized polymeric side chain precursors; and
e) synthesizing the multi-graft block copolymer compatibilizer by reacting the linear polymeric backbone including alkyne functional groups with the first azido-functionalized polymeric side chain precursor, the second azido-functionalized polymeric side chain precursor and the optional one or more additional azido-functionalized polymeric side chain precursors in the presence of a catalyst at an elevated temperature, preferably wherein the temperature is between about 60 and about 100° C., more preferably between about 75 and about 90° C. to produce a mixed-graft block copolymer compatibilizer.

In one embodiment, the catalyst is a copper catalyst and the reaction is a copper(I)-catalyzed azide-alkyne cycloaddition click reaction. In one embodiment, the copper catalyst comprises a reaction product of copper(I) halide complexes or copper(I) acetate.

In one embodiment, the alkyne-functionalized linear polymeric backbone precursor is selected from the group consisting of polymethacrylate, polyacrylate, polystyrene, polyester, polynorbornene, polydimethylsiloxane, polyacrylamide and combinations thereof.

In one embodiment, the alkyne-functionalized linear polymeric backbone precursor exhibits a polydispersity index ranging from about 1.1 to about 2.0. In one embodiment, the polydispersity index is less than about 2.0, more preferably the polydispersity index is less than about 1.5, more preferably the polydispersity index is less than about 1.3.

In one embodiment, the alkyne-functionalized linear polymeric backbone precursors comprise between about 10 and about 5,000 alkyne repeat units, preferably in the range of about 20 to about 4,000 alkyne repeat units, or in the range of about 25 to about 3,000 alkyne repeat units, or in the range of about 30 to about 2,000 alkyne repeat units, or in the range of about 35 to about 1,000 alkyne repeat units or within the range of about 40 to about 500 alkyne repeat units.

In one embodiment, the polymer of the first azido-functionalized polymeric side chain precursor, the second azido-functionalized polymeric side chain precursor, and the optional one or more additional azido-functionalized polymeric side chain precursors are each selected from the group consisting of polyethylene, polystyrene, isotactic polypropylene, atactic polypropylene, poly(methyl methacrylate), polyacrylate, polyacrylamide, polydimethylsiloxane, poly(lactic acid), poly(ethylene oxide), and polycaprolactone.

In one embodiment, the ratio of the first azido-functionalized side chain precursor to the second azido-functionalized side chain precursor is in the range of 99:1 to 1:99, preferably in the range of 90:10 to 10:90, more preferably in the range of 80:20 to 20:80, even more preferably in the range of 30:70 to 70:30.

In one embodiment, the azido-functionalized polymeric side chain precursors are randomly grafted to the linear polymeric backbone.

In one embodiment, the molecular weight of each azido-functionalized polymeric side chain precursor is in the range of about 1,000 to about 30,000 Da, or in the range of about 2,000 to about 25,000 Da, or in the range of about 5,000 to about 20,000 Da, or in the range of about 7,000 to about 15,000 Da, or in the range of about 6,000 to about 10,000 Da.

In one embodiment, the mixed-graft block copolymer compatibilizer (or a combination of two or more dissimilar mixed-graft block copolymer compatibilizers) is incorporated into dissimilar polymers at a loading ranging from range of about 0.05 to about 5.0 wt. %, more preferably in the range of about 0.1 to about 3 wt. %, more preferably about 0.5 to about 1.0 wt. %. As discussed above, the dissimilar polymers may include two or more of polyolefins (e.g., polypropylene and polyethylene), polystyrene, polar vinyl polymers (e.g., polyacrylate, polymethacrylate, and polyacrylamide), poly(lactic acid), poly(ethylene oxide), polycaprolactone, polydimethylsiloxane, or combinations thereof.

In one embodiment, the compatibilized blend of the mixed-graft block copolymer compatibilizer(s) and dissimilar polymers has an elongation at break ranging from about 20% to about 1000%, or in the range of 100% to 900% or in the range of 200% to 800%, or in the range of 300% to 700%.

In one embodiment, the mixed-graft block copolymer compatibilizer includes a linear polymeric backbone tethered to two or more types of polymeric side chains selected from the group consisting of polyethylene, polystyrene, isotactic polypropylene, atactic polypropylene, poly(methyl methacrylate), polyacrylate, polyacrylamide, polydimethylsiloxane, poly(lactic acid), poly(ethylene oxide), and polycaprolactone.

In one embodiment, the linear polymeric backbone of the mixed-graft block copolymer compatibilizer has a molecular weight up to about 1,000,000 g/mol, more preferably in the range of about 20,000 to about 1,000,000 g/mol.

In one embodiment, the frequency of the two or more types of polymeric side chains tethered along the linear backbone ranges from about every 10 to about every 200 carbon atoms, or from about every 20 to about every 175 carbon atoms, or from about every 30 to about every 150 carbon atoms, or from about every 40 to about every 125 carbon atoms, or from about every 50 to about every 100 carbon atoms along the linear polymeric backbone.

In one embodiment, the synthesis of linear polymeric backbone, the first azido-functionalized polymeric side chain precursor, the second azido-functionalized polymeric side chain precursor, and optional one or more additional azido-functionalized polymeric side chain precursors occurs in a solvent, which solvent may be selected from one or more of xylene, dichlorobenzene, trichlorobenzene, dimethylformamide, toluene, anisole, and benzene.

In one embodiment, the compatibilized polymer blend exhibits at least a 100% increase in elongation at break, preferably at least a 1,000% increase in elongation, more preferably at least a 10,000% increase in elongation as compared with a blend of the dissimilar polymers not including the mixed-graft block copolymer compatibilizer.

In one embodiment, the compatibilized polymer blend exhibits at least a 100% increase in toughness, preferably at least a 1,000% increase in toughness, more preferably at least a 10,000% increase in toughness as compared with a blend of the dissimilar polymers not including the mixed-graft block copolymer compatibilizer.

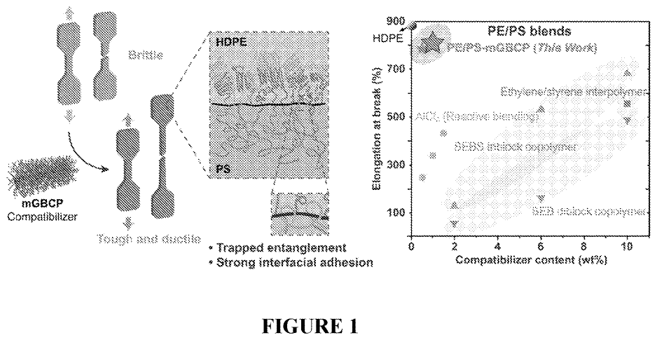

As shown in FIG. 1, a blend HDPE/PS 70/30 that includes an mGBCP in accordance with the present invention exhibited a much higher elongation % at break at a much lower wt. % that other compatibilizers such as an in-situ formation of PS-g-PE catalyzed by AlCl₃ in a LLDPE/PS 80/20 blend; a HDPE/PS 80/20 blend with poly[styrene-b-(ethylene-co-butylene)-b-styrene](SEBS) triblock copolymer (available from Shell Chemical); a HDPE/PS 80/20 blend with poly[styrene-h-(ethylene-co-butylene)](SEB) diblock copolymer (available from Japan Synthetic Rubber); and a HDPE/PS 67/33 blend with ethylene/styrene interpolymer (Dow Chemical).

The invention will now be explained in accordance with the following non-limiting examples:

### EXAMPLES

### Example 1

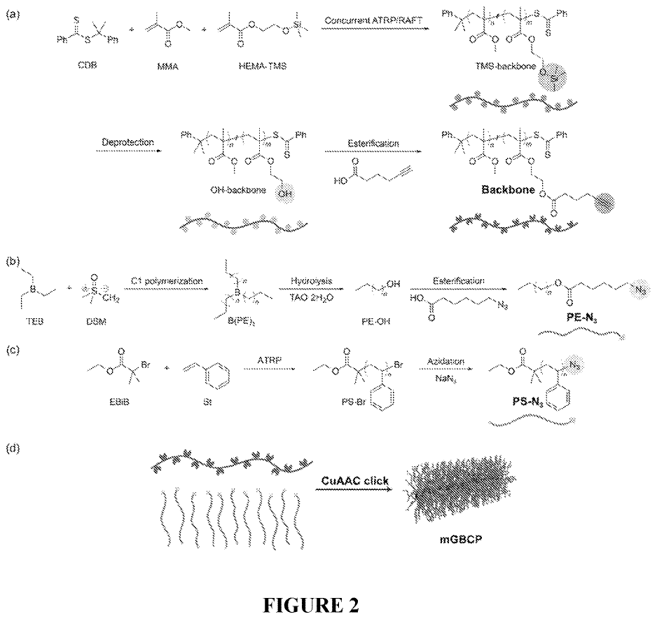

Scheme 1, which is depicted in FIGS. 2(a)-(d), presents the synthetic route of mGBCPs through Cu(I)-catalyzed azide-alkyne cycloaddition (CuAAC) of alkyne-functionalized polymethacrylate backbone and azido-functionalized polyethylene and polystyrene side chains.

The synthesis of backbones with varied molecular weights (67 kDa, 177 kDa, 390 kDa, denoted as Backbone1, Backbone2, Backbone3, respectively) started with the copolymerization of methyl methacrylate (MMA) and 2-(trimethylsilyloxy)ethyl methacrylate (HEMA-TMS) mediated with a concurrent atom transfer radical polymerization (ATRP) and reversible addition-fragmentation chain transfer (RAFT) mechanism. This dual reversible deactivation mechanism significantly suppressed radical terminations and enabled the preparation of well-defined backbone precursors with ultrahigh molecular weight (MW>50 kDa) and low dispersity (D<1.4). MWs were tuned by varying the feed ratio of monomer to chain-transfer agent (CTA) cumyl dithiobenzoate (CDB). An MMA to HEMA-TMS ratio of 9/1 was maintained to provide a consistent TMS group density and distribution in the resulting backbone due to the similar reactivity of the two comonomers. TMS groups served as reaction sites for the further functionalization with the alkyne group. Specifically, the backbone precursor underwent deprotection with tetrabutylammonium fluoride (TBAF) and subsequent esterification with 5-hexynoic acid, generating backbones bearing alkyne groups ready for click reaction.

FIG. 2(a) depicts the synthesis of an alkyne-functionalized PMMA backbone. A summary of the synthesis of backbones TMS-backbone1, TMS-backbone2, and TMS-backbone3 is provided below in Table 1.

TABLE 1
Summary of the synthesis of Backbones

| Backbone | M_{n, GPC} ^{a} | | | M_{n, GPC} ^{a} | |
|---|---|---|---|---|---|
| precursor | (kDa) | Ð ^{a} | Backbone | (kDa) | Ð ^{a} |
| TMS-backbone1 | 65.8 | 1.33 | Backbone1 | 67.0 | 1.30 |
| TMS-backbone2 | 152 | 1.12 | Backbone2 | 177 | 1.26 |
| TMS-backbone3 | 349 | 1.14 | Backbone3 | 390 | 1.53 |

^{a} Determined by GPC with THF as eluent and PMMA as standards.

The polyethylene and polystyrene side chains were respectively synthesized using C₁ polymerization and ATRP with highly preserved chain end functionality, so that azido-functionalized side chains could be readily prepared through post-polymerization chain end transformation. FIG. 2(b) depict a synthesis of PE-N₃ side chains and FIG. 2(c) depicts a synthesis of PS-N₃ side chains.

C1 polymerization employed triethylborane (TEB) as an initiator and dimethylsulfoxonium methylide (DSM) as the monomer, with one methylene group inserted during one chain propagation cycle. The synthesized polymethylene was structurally identical to polyethylene, and avoided formation of branches that frequently occurs in conventional ethylene polymerization methods. Hydroxyl-functionalized PE (PE-OH) was synthesized via C1 polymerization followed by the hydrolysis of tri(polymethylene)borane with trimethylamine N-oxide dihydrate (TAO·2H₂O). The number-average molecular weight (M_{n,NMR}) was evaluated by nuclear magnetic resonance (NMR) spectroscopy to be 14 kDa.

PE-N₃-14k was then obtained by the esterification with an o-azido carboxylic acid. On the other hand, PS-Br with a -Br chain end was synthesized via ATRP of styrene (St), where a high feed ratio of monomer to initiator (EBiB) (1000/1) and low monomer conversion (20%) were applied to ensure the high chain end fidelity. The theoretical molecular weight (M_{n,theo}) was calculated to be 20 kDa for a controlled polymerization based on the monomer conversion. The Br-chain end of PS-Br-20k was then substituted with sodium azide to produce PS-N₃-20k. A GPC molecular weight (M_{n,GPC}) of 17 kDa was determined by gel permeation chromatography (GPC). It is noteworthy that the lengths of both side chains were significantly shorter compared to the block length of BCPs required for an efficient compatibilization (e.g., the MW of PE block >100 kDa in BCPs and >20 kDa in MBCPs).

The inventors of the present disclosure believe that a molecular weight of the side chain slightly above the entanglement molecular weight would be sufficient in mGBCP architecture for compatibilization due to the additive effect of multiple side chains that all entangled with homopolymers, as well as the trapped entanglement of homopolymers with the backbone. In addition, the lack of branching in PE side chains would potentially enhance the cocrystallization and achieve a similar degree of crystallization to regular polyethylene synthesized from coordination polymerization with a much higher MW. The employment of shorter side chains greatly simplifies the synthesis and lower the costs.

mGBCPs were then synthesized from Backbone1, Backbone2, and Backbone3 described above, PE-N₃-14k, and PS-N₃-20k through CuAAC click reaction with the same molar ratio of PE-N₃-14k and PS-N₃-20k, which was half of the molar amount of the alkyne functional groups on the backbone. An elevated temperature at 85° C. was applied to overcome a limited solubility of PE and provide a homogeneous reaction.

mGBCP1, mGBCP2, and mGBCP3 were converted from Backbone1, Backbone2, and Backbone3, respectively, with an increasing backbone length. The conversion of functional groups was not complete, and the product was directly used as precipitated without the removal of unreacted side chains. The synthesis of mGBCP is depicted in FIG. 2(d).

HDPE and PS are immiscible polymers with a reported X value of 0.07. Macroscopic phase separation occurred when blending these two polymers and a droplet-in-matrix morphology was observed when HDPE was the majority with a weight fraction of 70%.

To investigate the effect of mGBCPs on the blend properties, HDPE/PS/mGBCP blends with a weight ratio of 70/30/w, were prepared by solvent mixing followed with a precipitation-based isolation step. It is noted that w was chosen to be 0.1, 0.2, 0.5, 1, and 3, and the corresponding weight fraction of mGBCP was 0.1%, 0.2%, 0.5%, 0.99% (˜1%), and 2.9% (3%), respectively.

To simplify the discussion, w=1 and w=3 will be used interchangeably with 1 wt. % and 3 wt. % of mGBCP in the following content. The thoroughly dried polymer blends were pressed into a thin film (thickness <1 mm) pneumatically at 180° C. for 12 min. A second press was necessary to further homogenize the blend. The films were employed in subsequent studies as set forth below.

It should be further noted that the impact of the polymethacrylate backbone on the phase behaviors cannot be ignored. The y between PS and poly(methyl methacrylate) (PMMA) is 0.04, while the X between HDPE and PMMA is 1.4, indicating the strong immiscibility between HDPE and PMMA.

Accordingly, it is believed that the polymethacrylate backbone will be concentrated near the interface but mainly embedded in the polystyrene domain due to its covalent linkage with the polystyrene side chains, while polyethylene side chains crystallize and entangle with HDPE. This conformation is postulated to be more energetically favored compared to other possibilities.

The mechanical properties of the blends were evaluated using uniaxial tensile tests. Strong but brittle polystyrene possess a high Young's modulus (2200 MPa) but low elongation at break (ε_{b}) (2%), while ductile and tough HDPE can achieve a high Eb (880%) yet a relatively lower Young's modulus (290 MPa). Blending the two polymers without any additives resulted in a material with inferior mechanical properties of both low Young's modulus (620 MPa) and low Eb (8%). Since HDPE formed a continuous major phase, the failure of the blend originated from chain pullout at the interface.

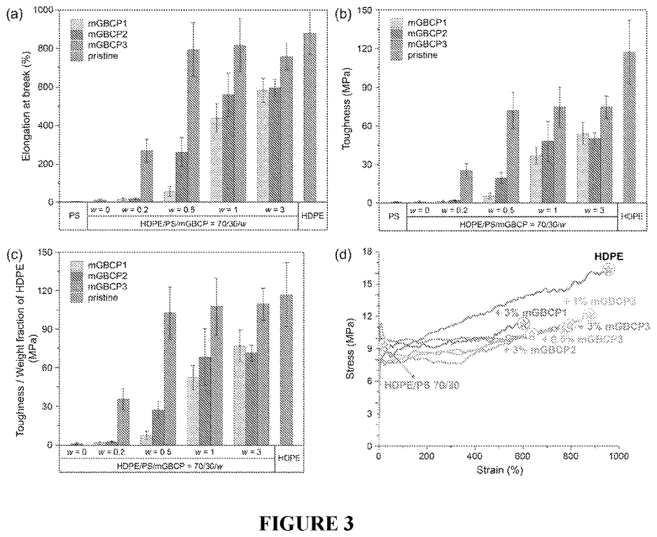

The addition of 0.1 wt. % of the synthesized mGBCPs led to no improvement due to low coverage of the interface. As shown in FIG. 3, when increasing the content of the synthesized mGBCP1 to 0.2 wt. % and 0.5 wt. %, a slight increase in ε_{b} and toughness was achieved. Further increasing the content of the synthesized mGBCP1 to 3 wt. % provided an ε_{b} of 580%, which surpasses the performance of most reported compatibilizers for polyethylene/polystyrene blends. The toughness increased accordingly to 54 MPa, almost 70 times higher than that of the pristine blend. Extending the backbone length of mGBCP further gave rise to a better compatibilization enabled by a stronger additive effect.

FIGS. 3(a) to 3(d) depict the mechanical properties of the HDPE/PS/mGBCP blends. As shown in FIG. 3(a), with the presence of only 1 wt. % mGBCP2, the blend showed an E, of 560%, and only 0.5 wt. % of mGBCP3 promoted the ε_{b} to 790%. The plateau of ε_{b} vs compatibilizer content was observed in mGBCP2 and mGBCP3, and it appeared earlier with a higher molecular weight of the backbone, i.e., mGBCP3. This indicated the saturation of mGBCPs at the interface. The highest ε_{b} was reached when 1 wt. % of mGBCP3 was employed, generating blends with comparable ductility as HDPE.

FIG. 3(b) demonstrates that the toughness was reinforced with increasing backbone length and compatibilizer content in a similar trend to E, while the value was overall lower than that of HDPE. The discrepancy was attributed to the existence of PS phase that weight-averaged the high-toughness HDPE domain. To prove this, toughness normalized by the weight fraction of HDPE was plotted with a highest value approaching that of HDPE as shown in FIG. 3(c). FIG. 3(d) depicts stress-strain curves of polymer blends.

The addition of mGBCP compatibilizers decreased the Young's modulus (E) of the blends. The compatibilized blends exhibited an up to one-fold decrease in E relative to the pristine blend, although still higher than that of HDPE as shown in Table 2.

Modulus of a blend is dictated by its components excluding the influence of interfaces. The bottlebrush-like architecture provides an intrinsic low modulus due to its high entanglement MW and large diameter of polymer strands, thus causing a negative effect on the modulus of the entire blend. This phenomenon is not uncommon in the compatibilized HDPE/PS blends, where an increasing concentration of compatibilizers led to a decreasing modulus. By using mGBCPs as compatibilizers, this drawback was minimized as a low concentration of compatibilizer was needed. Adding 3 wt. % of mGBCPs still produced blends with E higher than that of HDPE.

TABLE 2
Mechanical properties of HDPE/PS 70/30 blends with compatibilizers

| | | Elon- | | | | Toughness/ |
|---|---|---|---|---|---|---|
| | | gation | Ultimate | Young's | Tough- | wt. % of |
| | | at break | stress | modulus | ness | HDPE |
| Blend | w | (%) | (MPa) | (MPa) | (MPa) | (MPa) |
| HDPE | N/A^{a} | 875 | 17.1 | 288 | 117 | 117 |
| PS | N/A^{a} | 2.18 | 36.8 | 2230 | 0.45 | N/A^{a} |
| HDPE/PS | N/A^{a} | 8.30 | 8.9 | 622 | 0.76 | 1.08 |
| 70/30 | | | | | | |
| HDPE/PS/ | 0.2 | 13.8 | 9.0 | 522 | 1.24 | 1.78 |
| mGBC | | | | | | |
| P1 | 0.5 | 54.4 | 9.3 | 399 | 5.22 | 7.45 |
| 70/30/w | 1 | 437 | 9.3 | 379 | 36.7 | 53.0 |
| | 3 | 578 | 10.8 | 362 | 53.8 | 79.1 |
| HDPE/PS/ | 0.2 | 18.0 | 10.0 | 421 | 1.77 | 2.53 |
| mGBC | | | | | | |
| P2 | 0.5 | 259 | 7.7 | 438 | 19.3 | 27.5 |
| 70/30/w | 1 | 557 | 9.0 | 451 | 47.8 | 69.0 |
| | 3 | 592 | 10.3 | 451 | 49.9 | 73.4 |
| HDPE/PS/ | 0.2 | 267 | 9.5 | 374 | 24.8 | 35.4 |
| mGBC | | | | | | |
| P3 | 0.5 | 789 | 10.8 | 339 | 71.8 | 103 |
| 70/30/w | 1 | 812 | 10.6 | 346 | 74.6 | 108 |
| | 3 | 751 | 11.1 | 361 | 74.7 | 110 |

^{a}Not applicable.

As further evidence of decreased interfacial tension, a decreased droplet size after adding compatibilizers was microscopy-imaged. To preserve the blend morphology, cryo-microtoming at −120° C. was conducted to thin-slice the samples. The cross-section was a representative of the blend morphology, and was examined under scanning electron microscopy (SEM) after removing the polystyrene phase with tetrahydrofuran washing.

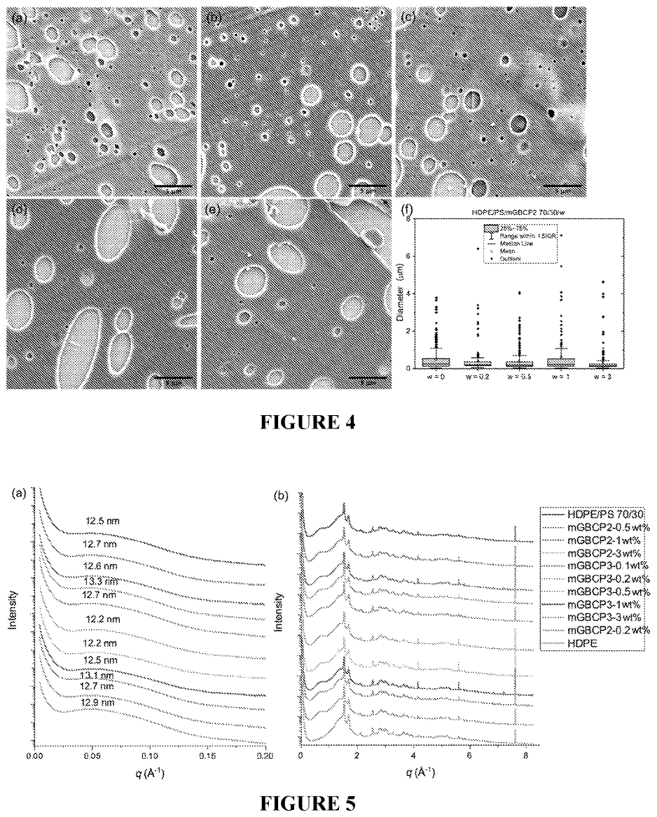

FIGS. 4(a)-(d) depicts SEM images and droplet size analysis results of HDPE/PS.mGBCP2 70/30/w blends. FIG. 4(a) depicts w=0, FIG. 4(b) depicts w=0.2, FIG. 4(c) depicts w=0.5; FIG. 4(d) depicts w=1, and FIG. 4(e) depicts w=3. A summary of droplet sizes in blends with different w, is shown in FIG. 4(f). As shown in FIGS. 4(a)-(f), increasing weight fraction of mGBCP2 did not result in a reduced droplet size. The diameter of the droplets mostly fell into the range of 0.3-0.6 m regardless of the compatibilizer content, and there were some outliers with considerably high values.

The unexpected phenomenon was believed to be on account of the following reasons: (1) fast precipitation from the solution kinetically trapped the blend morphology, while the following heat pressing process did not provide enough time to anneal; (2) the high molecular weight bottlebrush-like structure significantly decelerated the diffusion of mGBCPs, and therefore prevented the further development of new interfaces.

It was also demonstrated that processing conditions had a critical influence on the blend morphology and properties. In spite of this, mGBCPs residing at the interface were capable of strongly adhering the two phases, and promoting the mechanical properties of the blend without the decrease in domain size. It is believed that optimizing process conditions such as melt extrusion, heat press with programmed pressure and temperature, and thermal annealing of the blends will further enhance the mechanical properties and decrease the compatibilizer content. Non-limiting exemplary melt blending processes in which the mGBCPs disclosed herein may be utilized for compatibilizing mixed plastic waste streams include twin screw extrusion, single screw extrusion, and Brabender™ mixing. With each of these exemplary melt blending processes, the mGBCP compatibilizer may be separately metered into the mixing process or alternatively pre-mixed with the mixed plastic waste prior to introduction into the melt blending process.

One of the main contributions to the high toughness and ductility of HDPE is its semi-crystallinity. Therefore, maintaining the crystallinity of HDPE in the blend has a substantial effect to achieve a high elongation at break. The crystallinity was examined with wide-angle X-ray scattering (WAXS) and small-angle X-ray scattering (SAXS).

As shown in FIG. 5, the blending and addition of mGBCPs had trivial influence on the polymer crystallinity, evidenced by the same patterns in the SAXS/WAXS profiles of all samples. The linear PE side chains in mGBCPs were expected to contribute to the crystallization as well.

FIG. 6 depicts Young's modulus vs elongation at break of HDPE, PS, and their blends.

Example 1 demonstrates that mGBCPs are highly efficient compatibilizers in HDPE/PS blends that can boost their elongation at break to almost 100-fold higher than that of the uncompatibilized blend, with a weight concentration of the compatibilizer as low as 0.5 wt. %. The grafting-to synthetic strategy combined with the controlled synthesis of side chains ensured a high backbone length and well-defined side chains. The impact of backbone length and mGBCP content were investigated by the tensile tests of the blends, demonstrating that a longer backbone was critical for a high-performance and low-compatibilizer-content compatibilization.

By adding mGBCP3 with the longest backbone in this study, a HDPE/PS blend was produced that possessed a similar ductility and higher modulus compared to those of pure HDPE as shown in FIG. 6.

Further details in preparing the mGBCPs are described in Examples 2-6 below.

### Example 2

The synthesis of alkyne-functionalized backbones P(MMA-r-HEMA-yne), in particular the synthesis of trimethylsilyl (TMS)-protected backbone precursors P(MMA-r-HEMA-TMS) (TMS-Backbone) was performed by concurrent ATRP/RAFT.

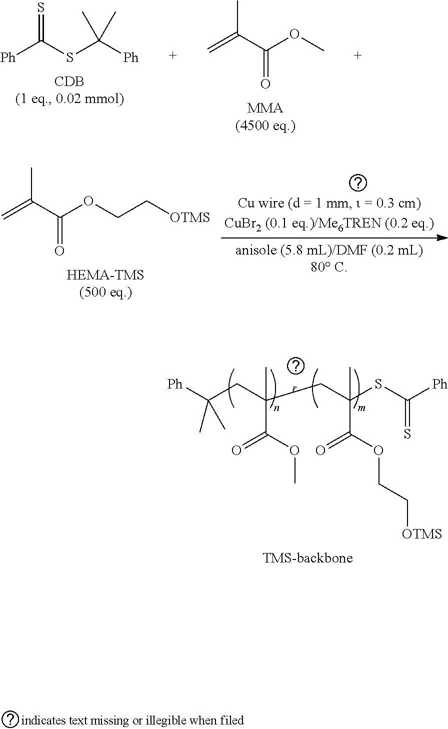

To a Schlenk flask with a magnetic stir bar, MMA (45 mmol, 4500 eq., 4.8 mL), HEMA-TMS (5 mmol, 500 eq., 1.0 mL), anisole (5.8 mL), CuBr₂/Me₆TREN/DMF stock solution (0.00105 mmol/0.00315 mmol, 0.105 eq./0.315 eq., 0.1 mL) and CDB/DMF stock solution (0.01 mmol, 1 eq., 0.1 mL) were added. The mixture was cooled to 0° C. and sparged with N₂ for 20 min.

A Cu wire (d=1 mm, l=0.3 cm) was then added into the solution under N₂ protection, and the mixture was sparged for another 5 min. The reaction was stirred at 80° C. for 40 hours and quenched by opening cap, adding THE and a droplet of H₂O₂ solution. The polymer was purified by passing through a neutral Al₂O₃ column followed by precipitation in hexanes twice. The final product was a slightly pink solid with a yield of 27%.

A series of TMS-containing precursors (denoted as TMS-backbone) were synthesized with three different target DPs, the same ratio of [MMA]/[HEMA-TMS], and the same initial monomer concentration, as shown in Table 3.

TABLE 3
Summary of the synthesis of P(MMA-r-HEMA-TMS).

| | | Conver- | | | |
|---|---|---|---|---|---|
| | [MMA]/[HEMA- | sion^{a} | M_{n,GPC} ^{b} | | Yield |
| | TMS]/[CDB] | (%) | (kDa) | Ð ^{b} | (%) |
| TMS-backbone1 | 1800/200/1 | 19 | 65.8 | 1.33 | 13 |
| TMS-backbone2 | 4500/500/1 | 32 | 152 | 1.12 | 27 |
| TMS-backbone3 | 7200/800/1 | 36 | 349 | 1.14 | 29 |

^{a}Determined by NMR.
^{b} Determined by GPC with THF as eluent and PMMA as standards.

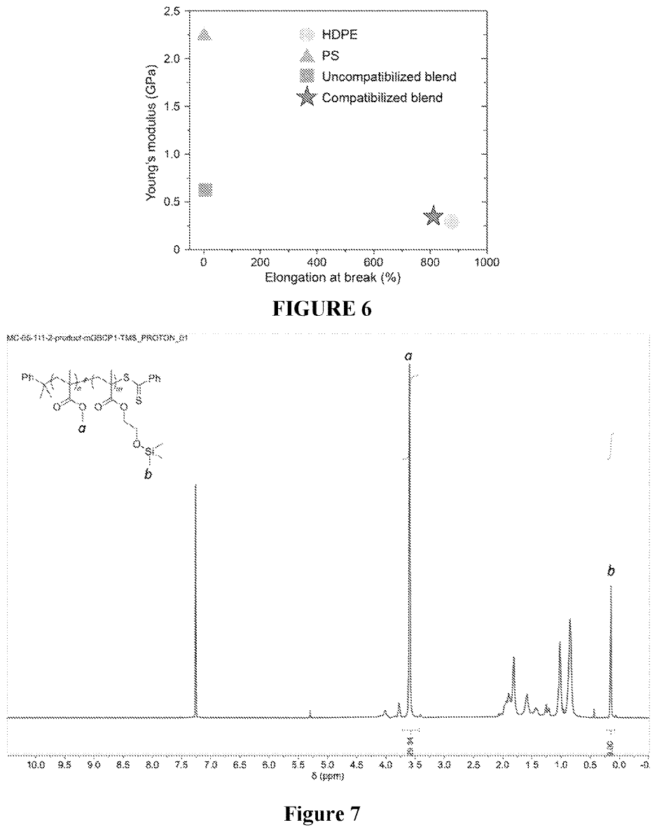

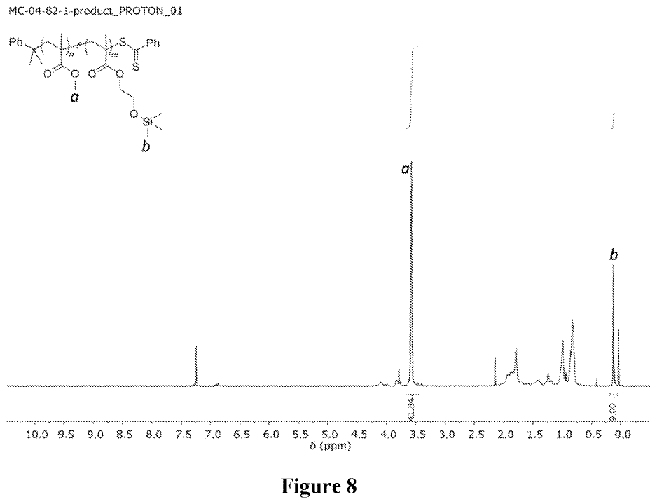

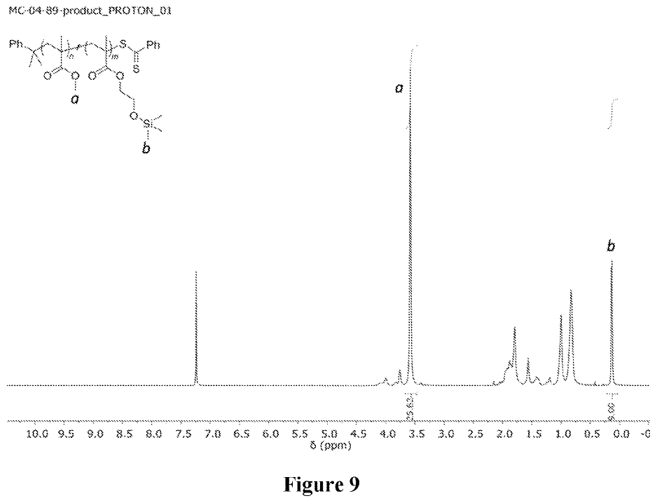

FIG. 7 depicts a ¹H NMR spectrum of TMS-backbone1 in CDCl₃. FIG. 8 depicts a ¹H NMR spectrum of TMS-backbone2 in CDCl₃. FIG. 9 depicts a ¹H NMR spectrum of TMS-backbone3 in CDCl₃.

### Example 3

The synthesis of hydroxyl-functionalized backbone precursors P(MMA-r-HEMA) (OH-backbone) was performed according to the following.

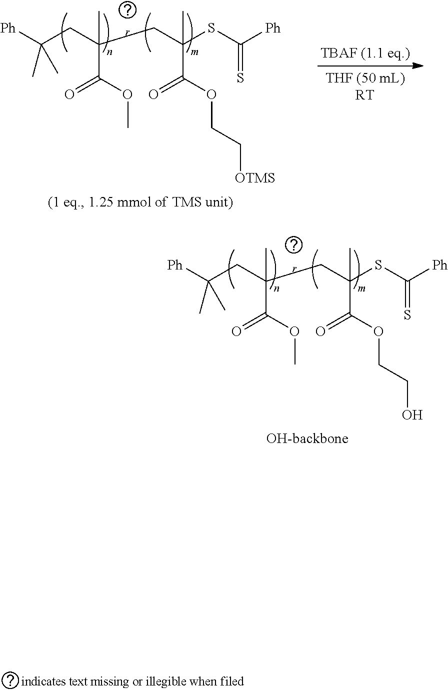

To a round bottle flask, TMS-backbone2 (1.25 mmol of TMS units, 1 eq., 1.38 g) and anhydrous THE (50 mL) was added. The mixture was cooled to 0° C. and a THF solution (1.0 M, 1.38 mL) of TBAF (1.38 mmol, 1.1 eq.) was added dropwise under N₂ protection. The reaction was gradually warmed to room temperature and stirred overnight. The mixture turned slightly yellow but remained clear. THF was then removed under reduced pressure. The crude product was dissolved in DCM and precipitated in CH₃OH. A hard, colorless solid OH-backbone2 was obtained in quantitative yield.

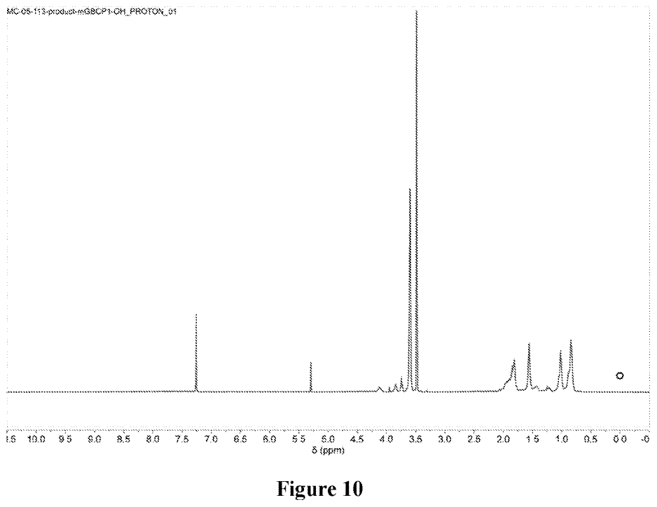

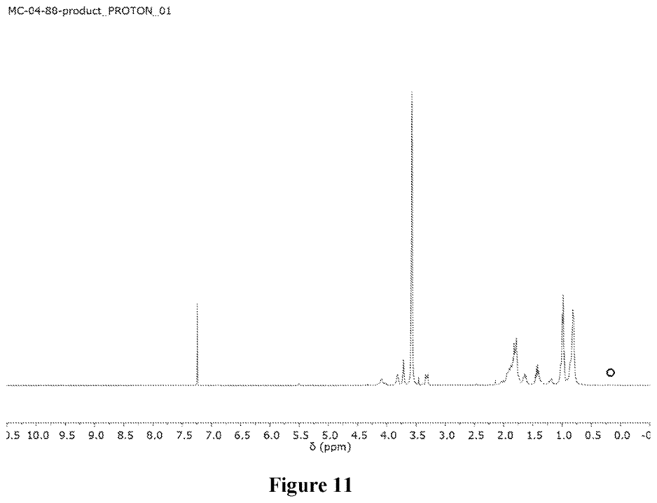

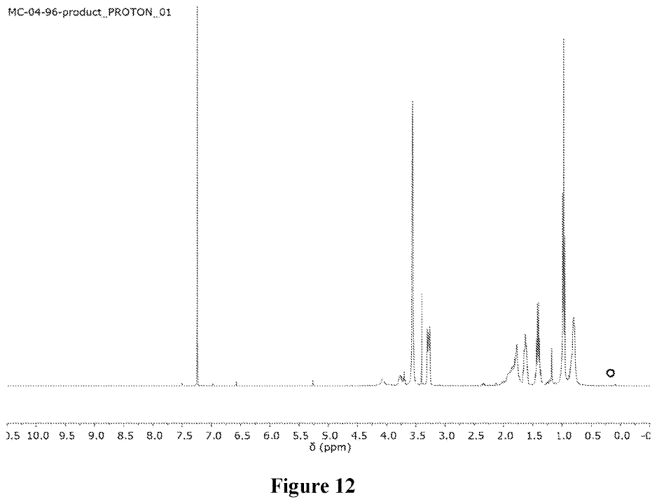

OH-backbone1 and OH-backbone3 were synthesized following the same procedure, and the complete removal of TMS-groups were confirmed by NMR spectra as shown in FIGS. 10 through 12. FIG. 10 shows the ¹H NMR spectrum of OH-backbone1 in CDCl₃. FIG. 11 shows the ¹H NMR spectrum of OH-backbone2 in CDCl₃. FIG. 12 shows the ¹H NMR spectrum of OH-backbone3 in CDCl₃.

### Example 4

The synthesis of alkyne-containing backbones P(MMA-r-HEMA-yne) (Backbone) was performed according to the following.

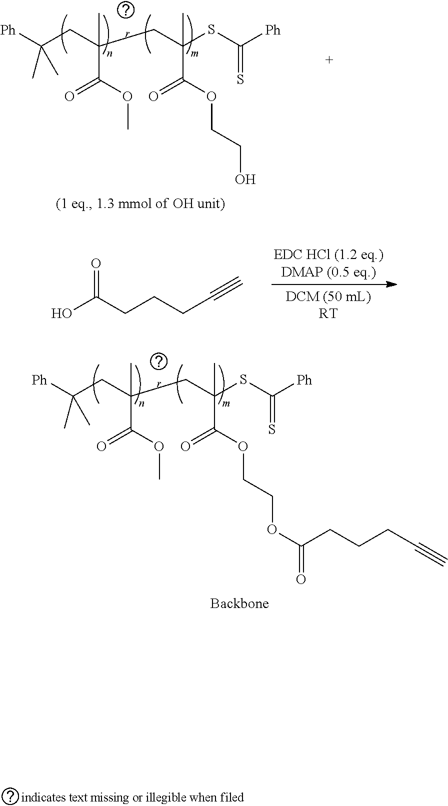

5-Hexynoic acid (1.3 mmol, 1 eq., 144 μL), 1-(3-dimethylaminopropyl)-3-ethylcarbodiimide hydrochloride (EDC·HCl) (1.56 mmol, 1.2 eq., 299 mg), and DMAP (0.60 mmol, 0.5 eq., 73 mg) were dissolved in dry DCM (30 mL) and stirred for 10 min. A DCM solution (20 mL) of OH-backbone2 (1.3 mmol of OH units, 1 eq., 1.34 g) was then added. After being stirred overnight, the mixture was diluted with DCM (100 mL) and washed with HCl (aqueous, 0.1 M, 150 mL), NaHCO₃(aqueous, saturated, 150 mL), and DI water (150 mL) sequentially. The organic phase was dried over Na₂SO₄ until clear, concentrated, and precipitate into hexanes. A white solid was obtained in 75% yield.

The esterification reaction was conducted twice for each backbone to achieve a higher alkyne functionality. Backbone2 and Backbone3 were synthesized following the same procedure.

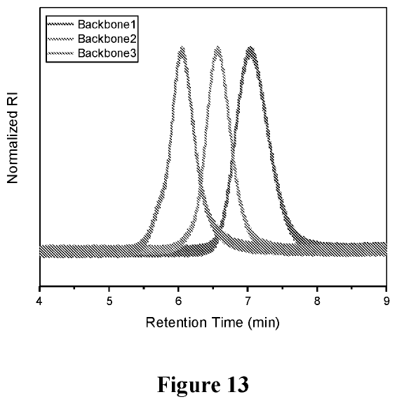

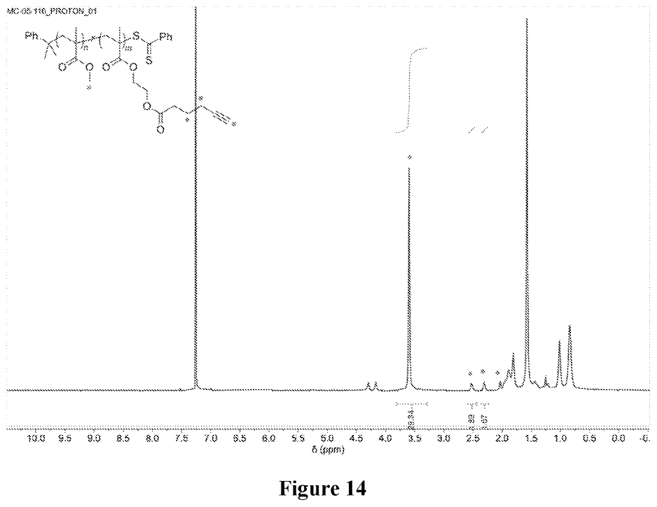

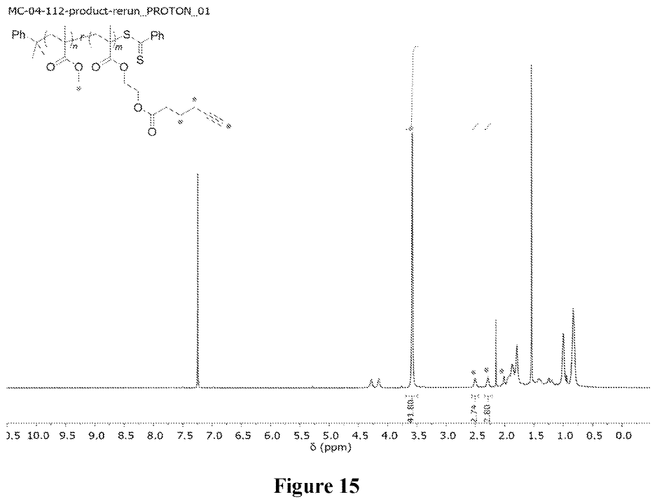

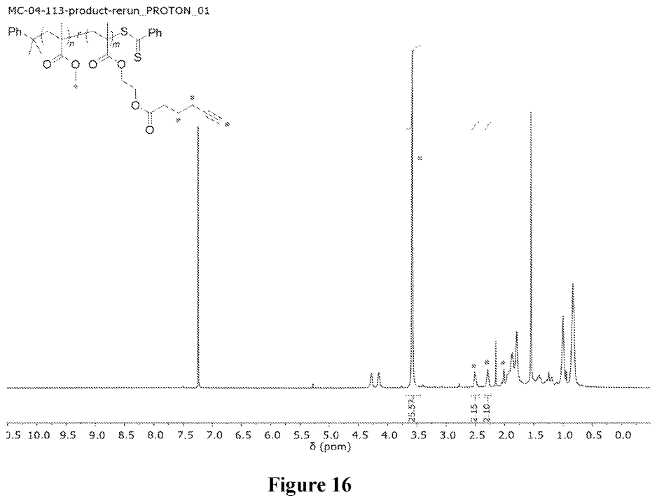

FIG. 13 depicts GPC traces of alkyne-containing backbones (THF as eluent). The complete removal of TMS-groups were confirmed by NMR spectra as shown in FIGS. 14 through 16. FIG. 14 shows the ¹H NMR spectrum of Backbone1 in CDCl₃. FIG. 15 shows the ¹H NMR spectrum of Backbone2 in CDCl₃. FIG. 16 shows the ¹H NMR spectrum of Backbone3 in CDCl₃.

### Example 5

The synthesis of azido-functionalized polystyrene side chain PS-N₃-20k was performed according to the following.

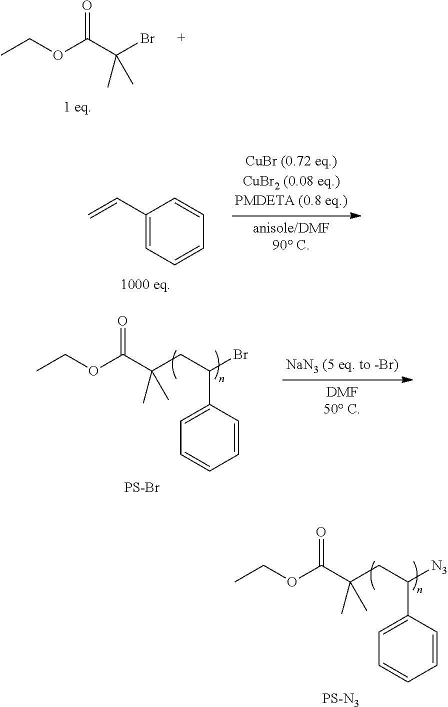

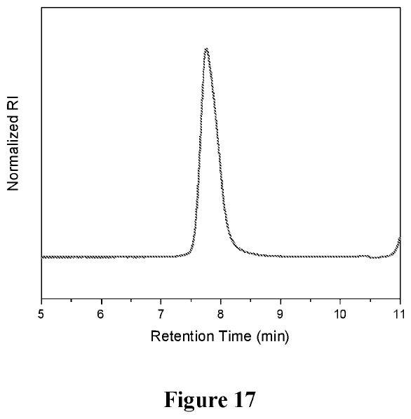

To a Schlenk flask equipped with a magnetic stir bar, styrene (0.240 mol, 1000 eq., 27 mL), CuBr₂ (0.0192 mmol, 0.08 eq., 4.3 mg), PMDETA (0.192 mmol, 0.80 eq., 40.1 L), EBiB (0.24 mmol, 1.0 eq., 35.2 L), DMF (0.40 mL), and anisole (4.0 mL) were added. The mixture was cooled to 0° C. and sparged with N₂ for 30 min. CuBr (0.1728 mmol, 0.72 eq., 24.8 mg) was then added into the solution under N₂ protection, and the mixture was sparged for another 10 min. The reaction was stirred at 90° C. for 26 hours and quenched by being exposed to air and adding THF. The polymer was purified by passing through a neutral Al₂O₃ column followed by precipitation in cold methanol twice. The monomer conversion was 20% and the M_{n,theo} was 20 kDa. 5.5 g of the final product PS-Br-20k was obtained as a white solid with M_{n,GPC} of 16 kDa and D of 1.09 (PS as standards). FIG. 17 depicts a GPC trace of PS-Br-20k (THF as eluent).

PS-Br-20k (0.10 mmol, 1 eq., 1.8 g) and NaN₃ (0.50 mmol, 5 eq., 32.6 mg) were dissolved in DMF (30 mL). The reaction mixture was stirred at 50° C. overnight, then diluted with ethyl acetate (150 mL). NaN₃ and DMF was extracted with DI H₂O (150 mL) for 3 times. The organic layer was dried over Na₂SO₄ and concentrated by rotary evaporator. After being precipitated in methanol, the product was obtained as a white solid with M_{w,GPC} of 17 kDa and D of 1.09 (PS as standards) in a yield of 87%.

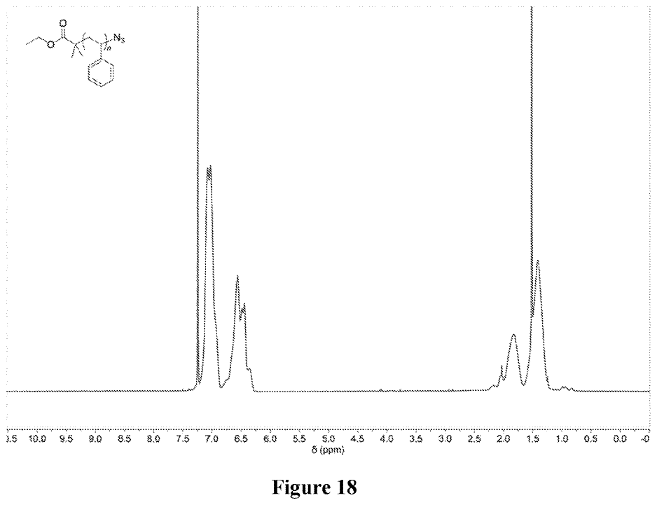

FIG. 18 depicts an ¹H NMR spectrum of PS-N₃-20k in CDCl₃. FIG. 19 depicts a GPC trace of PS-N₃-20k (THF as eluent).

### Example 6

The synthesis of azido-functionalized polyethylene side chains was performed according to the following.

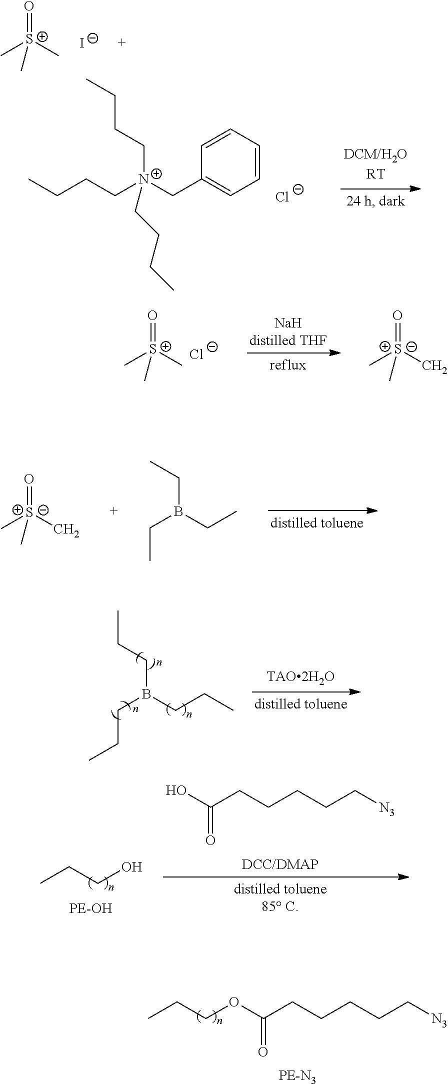

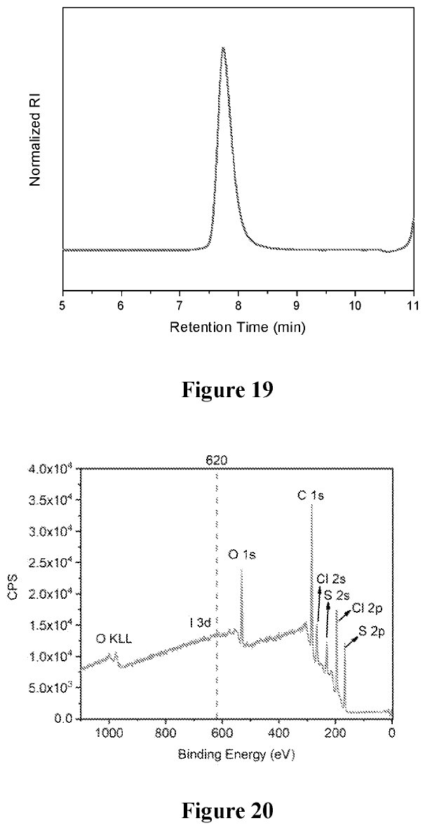

Trimethylsulfoxonium iodide (0.1 mol, 1 eq., 22.0 g) and tributylbenzylammonium chloride (0.11 mol, 1.1 eq., 34.3 g) were dissolved in DCM (180 mL) and water (240 mL). The reaction was stirred vigorously in dark for 24 hours. After phase separation, the water phase was washed with DCM (70 mL) twice. The aqueous solution was then concentrated under reduced pressure and a white solid was obtained. The crude product was then recrystallized from methanol at 50° C., followed by slowly cooling to room temperature and put into freezer overnight. The white needle-like crystals were filtered and dried under vacuum at 50° C. for 24 hours. The final yield was 43%. The XPS profile of the product indicated complete transformation from iodide to chloride as shown in FIG. 20.

Into a 100 mL two-neck flask, NaH (0.083 mol, 2.0 g) was added and the flask was evacuated and refilled with N₂ for 3 times. Under N₂ protection, distilled THE (50 mL) and dry trimethylsulfoxonium chloride (0.078 mmol, 10 g) was added. The mixture was heated and refluxed at 90° C. for 5 hours. The THF was then removed under reduced pressure, followed by the addition of distilled toluene (20 mL). the suspension was stirred at room temperature for 30 min and filtered through dry Celite under N₂ protection. The filter cake was rinsed with distilled toluene (30 mL) and the combined filtrate was a clear colorless solution of the product. The concentration of the ylide was determined as 0.87 mol/L by the titration with HCl aqueous solution (0.1 M) with phenolphthalein as the indicator.

To a pre-baked 2-neck flask purged with N₂, ylide solution in toluene (0.87 mol/L, 50 mL, 43.5 mmol) was transferred and stirred for 30 min. Then, a THE solution of triethylborane (1.0 mol/L, 0.0483 mL, target DP=300) was injected to initiate the polymerization. After being stirred at 50° C. for 30 min, trimethylamine N-oxide dihydrate (0.483 mmol, 54.1 mg) was added and the mixture was stirred at 80° C. for 16 hours. After being cooled to 0° C., the mixture was poured into cold methanol. After filtration, a white solid was obtained in quantitative yield. DP_{NMR}=1010, M_{n,NMR}=14 kDa.

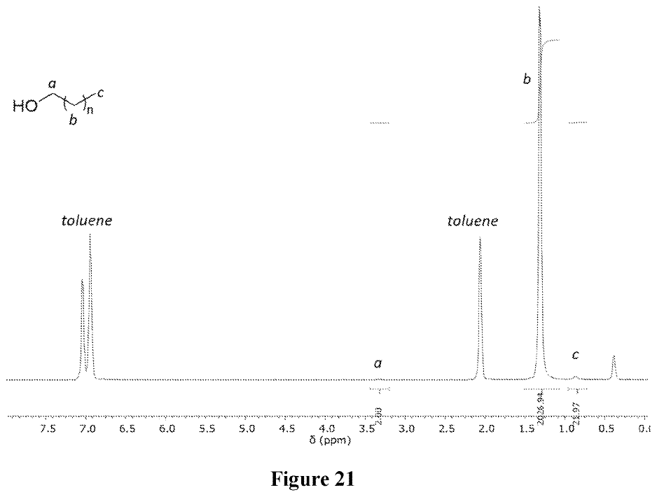

FIG. 21 depicts an ¹H NMR spectrum of PE-OH-14k in toluene-d₈ at 85° C.

To a vial, 6-azidohexanoic acid (0.15 mmol, 6 eq., 23.0 mg), N,N′-dicyclohexylcarbodiimide (DCC) (0.15 mmol, 6 eq., 30.9 mg) and dry toluene (5 mL) was added to obtain a white suspension. To a flask, PE-OH-14k (0.0025 mmol, 1 eq., 350 mg), 4-dimethylaminopyridine (DMAP) (0.0125 mmol, 0.5 eq., 1.5 mg) and dry toluene (5 mL) was added and heated to 85° C. The suspension of acid and DCC was then added into the flask. After 24 hours, the mixture was filtered through hot filter with cotton and then precipitated into methanol. A white solid was obtained in 82% yield.

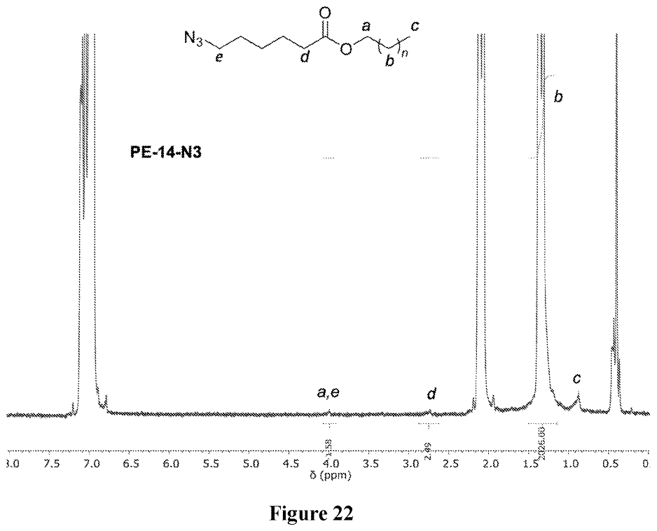

FIG. 22 depicts a ¹H NMR spectrum of PE-N₃-14k in toluene-d₈ at 85° C.

6-azidohexanoic acid was functionalized in accordance with the following:

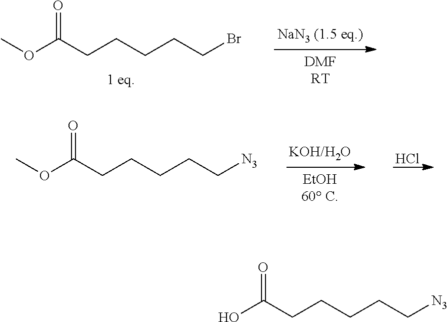

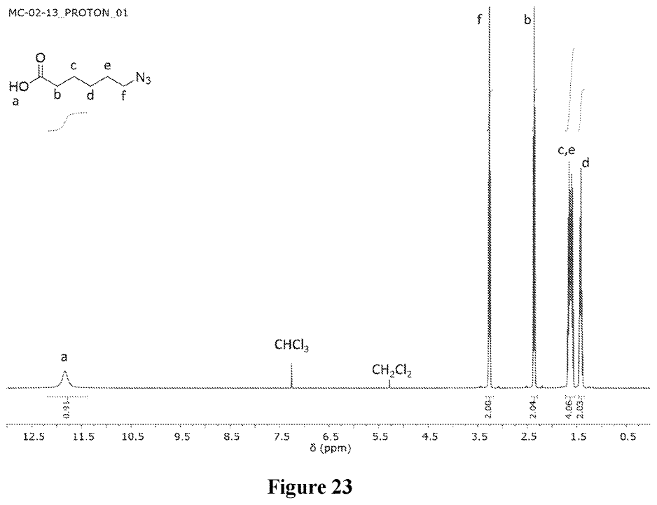

6-azidohexanoic acid was functionalized by reacting ethyl 2-bromohexanoate with NaN₃ in anhydrous DMF at room temperature and stirred overnight to yield a colorless liquid. Then the ethyl 2-azidehexanoate was hydrolyzed by KOH in a mixture of H₂O and EtOH at 60° C. for 3 h. A yellowish liquid was obtained in a total yield of 97%. FIG. 23 depicts a ¹H NMR spectrum of 6-azidohexanoic acid in CDCl₃.

### Example 7

mGBCPs were synthesized in accordance with the following procedures.

mGBCP1 was synthesized by the click reaction between Backbone1, PS-N₃-20k, and PE-N₃-14k. Accordingly, mGBCP2 and mGBCP3 were synthesized from Backbone2 and Backbone3 with same side chains respectively.

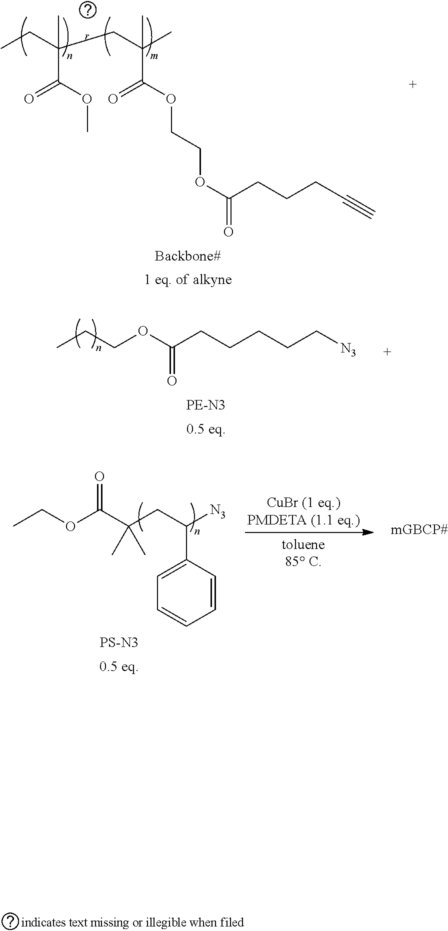

To a Schlenk flask equipped with a magnetic stir bar, Backbone1 (0.005 mmol of alkyne, 1 eq., 5.6 mg), PE-N₃-14k (0.0025 mmol, 0.5 eq., 35 mg), PS-N₃-20k (0.0025 mmol, 0.5 eq., 50 mg), and toluene (5.0 mL) were added. The mixture was cooled to 0° C. and sparged with N₂ for 20 min. A solution of CuBr/PMDETA/toluene (0.005 mmol/0.0055 mmol/0.25 mL, degassed) was then injected into the solution under N₂ protection. The reaction was stirred at 85° C. for 2 days and quenched by opening cap. The solution was then precipitated in cold methanol. After being dried, a white solid mGBCP1 was obtained in quantitative yield. This mGBCP product contained graft copolymers and unreacted side chains.

HDPE/PS/mGBCP 70/30/w (by weight) blends were prepared by mixing all polymers in xylene and heating for 2 hours. The solution was then poured into cold methanol followed by centrifugation. The blends were dried under vacuum at 80° C. for 1 day.

The dried blends were pressed at 180° C. for 12 min twice to form a coherent film, and cut into specimens with a gauge length of 25 mm and a gauge width of 6 mm. Tensile tests were performed under ambient conditions on an Instron 5960 mechanical testing system elongated with a crosshead velocity of 100%/min (25 mm/min) until specimen broke. At least five specimens were tested for each blend.

SEM samples were prepared by cryo-microtoming of heat-pressed films at −120° C. to 70 nm slices using a Leica Ultra Cryo UC7 equipped with a diamond knife. SEM samples were placed on silicon wafers, soaked in THF for 5 min to remove PS phase, and sputter coated with iridium. SEM imaging was performed on a Hitachi SU70 SEM at an accelerating voltage of 5.0 kV.

SAXS and WAXS measurements were conducted at the Soft Matter Interfaces beamline (12-ID) of the National Synchrotron Light Source II (NSLS-II) in Brookhaven National Laboratory with a beam energy of 16.1 eV. The sample-to-detector distance for SAXS was set as 8 meters.

### Example 8

mGBCPs including PP and PE brushes for compatibilizing polyethylene and polypropylene mixed plastic waste may be synthesized in accordance with the following procedures.

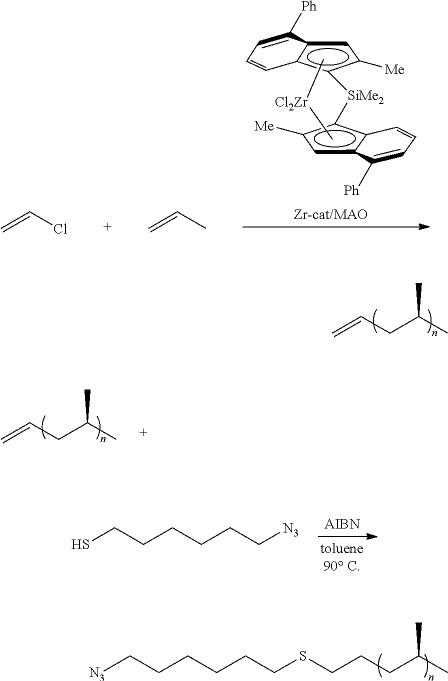

Methylaluminoxane (MAO) (2 mmol) is dissolved in toluene (100 mL) in a Fischer-Porter vessel in a glovebox. The Fischer-Porter vessel is then pressurized with 15 psig propylene gas. Another flask is filled with condensed vinyl chloride, followed by the addition of Zr-cat/toluene solution (2 μmol, 2.5 mL). The mixture is stirred at room temperature with a continuous feed of propylene, and quenched by adding methanol (5 mL). The polymer is precipitated out by being poured into 200 mL methanol. The product is further purified by dissolving in toluene, and the hot solution is filtered through Celite. After cooling the filtrate, the precipitate is collected and dried under vacuum at 80° C. to generate vinyl-terminated isotactic polypropylene.

Vinyl-terminated isotactic polypropylene (0.01 mmol), 6-azidohexane-1-thiol (0.05 mmol), AIBN (0.05 mmol), and toluene (50 mL) are added to a flask. The mixture is heated to 90° C. and stirred for 2 days. The solution is then poured into 300 mL cold methanol, and the precipitate is collected and dried under vacuum at 80° C. to generate the azido-terminated isotactic polypropylene (iPP-N₃).

Trimethylsulfoxonium iodide (0.1 mol) and tributylbenzylammonium chloride (0.11 mol) are dissolved in DCM (180 mL) and water (240 mL). The reaction is stirred vigorously in the dark for 24 hours. After phase separation, the water phase is washed with DCM (70 mL) twice. The aqueous solution is then concentrated under reduced pressure and a white solid is obtained. The crude product is then recrystallized from methanol at 50° C., followed by slowly cooling to room temperature and put into freezer overnight. The white needle-like crystals are filtered and dried under vacuum at 50° C. for 24 hours.

Into a 100 mL two-neck flask, NaH (0.083 mol) is added and the flask is evacuated and refilled with N₂ 3 times. Under N₂ protection, distilled THF (50 mL) and dry trimethylsulfoxonium chloride (0.078 mmol) is added. The mixture is heated and refluxed at 90° C. for 5 hours. The THF is then removed under reduced pressure, followed by the addition of distilled toluene (20 mL). The suspension is stirred at room temperature for 30 minutes and filtered through dry Celite under N₂ protection. The filter cake is rinsed with distilled toluene (30 mL) and the combined filtrate is a clear colorless solution of the product. The concentration of the ylide is determined by the titration with HCl aqueous solution (0.1 M) with phenolphthalein as the indicator.

To a pre-baked 2-neck flask purged with N₂, ylide solution in toluene (43.5 mmol) is transferred and stirred for 30 minutes. Then, a THF solution of triethylborane (0.0483 mmol) is injected to initiate the polymerization. After being stirred at 50° C. for 30 minutes, trimethylamine N-oxide dihydrate (0.483 mmol) is added and the mixture is stirred at 80° C. for 16 hours. After being cooled to 0° C., the mixture is poured into cold methanol. After filtration, a white solid is obtained as hydroxyl-functionalized polyethylene (PE-OH).

To a vial, 6-azidohexanoic acid (0.15 mmol), N,N′-dicyclohexylcarbodiimide (DCC) (0.15 mmol) and dry toluene (5 mL) is added to obtain a white suspension. To a flask, PE-OH (0.0025 mmol), 4-dimethylaminopyridine (DMAP) (0.0125 mmol) and dry toluene (5 mL) is added and heated to 85° C. The suspension of acid and DCC is then added into the flask. After 24 hours, the mixture is filtered through hot filter with cotton and then precipitated into methanol. A white solid is obtained as azido-functionalized polyethylene (PE-N3).

To a Schlenk flask equipped with a magnetic stir bar, Backbone3 (0.005 mmol of alkyne), iPP-N₃ (0.0025 mmol), PE-N₃ (0.0025 mmol), and toluene (5.0 mL) are added. The mixture is cooled to 0° C. and sparged with N₂ for 20 minutes. A solution of CuBr/PMDETA/toluene (0.005 mmol/0.0055 mmol/0.25 mL, degassed) is then injected into the solution under N₂ protection. The reaction is stirred at 85° C. for 2 days and quenched by opening cap. The solution is then precipitated in cold methanol. After being dried, a white solid is obtained as the mGBCP including iPP and PE side chains (mGBCP-PE/iPP). This mGBCP aims to compatibilize a blend of high-density polyethylene and isotactic polypropylene.

By adding at least about 0.2 wt. % to about 5.0 wt. % of a mGBCP-PE/iPP compatibilizer prepared by the method described herein and containing polyethylene and isotactic polypropylene side chains to a blend of high density polyethylene and isotactic polypropylene, a high density polyethylene and isotactic polypropylene compatibilized blend is produced and is expected to exhibit an elongation at break and Young's modulus comparable to those of virgin high density polyethylene or virgin isotactic polypropylene. The elongation at break of the compatibilized blend is expected to exhibit a 50-fold increase compared to the blend of high density polyethylene and isotactic polypropylene without adding mGBCP-PE/iPP compatibilizer.

### Example 9

The synthesis of azido-functionalized polyacrylate side chains can be performed according to the following.

To a Schlenk flask equipped with a magnetic stir bar, acrylate (0.240 mol, 1000 eq.), CuBr₂ (0.0192 mmol, 0.08 eq.), PMDETA (0.192 mmol, 0.80 eq., 40.1 μL), ethyl 2-bromopropionate (EBP) (0.24 mmol, 1.0 eq.), DMF (0.40 mL), and anisole (4.0 mL) are added. The mixture is cooled to 0° C. and sparged with N₂ for 30 minutes. CuBr (0.1728 mmol, 0.72 eq.) is then added into the solution under N₂ protection, and the mixture is sparged for another 10 minutes. The reaction is stirred at 60° C. for a period of time and quenched by being exposed to air and adding THF. The polymer is purified by passing through a neutral Al₂O₃ column followed by preparative GPC to generate bromo-functionalized polyacrylate. Bromo-functionalized polyacrylate (0.10 mmol, 1 eq.) and NaN₃ (0.50 mmol, 5 eq.) are dissolved in DMF (30 mL). The reaction mixture is stirred at 50° C. overnight, then diluted with ethyl acetate (150 mL). NaN₃ and DMF is extracted with DI H₂O (150 mL) 3 times. The organic layer is dried over Na₂SO₄ and concentrated by rotary evaporator to generate azido-functionalized polyacrylate.

The synthesis of azido-functionalized polyacrylamide side chains can be performed according to the following.

To a Schlenk flask equipped with a magnetic stir bar, acrylamide (0.24 mol, 1000 eq.), CuCl₂ (0.024 mmol, 0.10 eq.), tris[2-(dimethylamino)ethyl]amine (Me₆TREN) (0.24 mmol, 1.0 eq.), ethyl 2-chloropropionate (EClPr) (0.24 mmol, 1.0 eq.), DMF (0.40 mL), and DMSO (4.0 mL) are added. The mixture is cooled to 0° C. and sparged with N₂ for 30 minutes. CuCl (0.216 mmol, 0.90 eq.) is then added into the solution under N₂ protection, and the mixture is sparged for another 10 minutes. The reaction is stirred at 30° C. for a period of time and quenched by being exposed to air and adding THF. The polymer is purified by passing through a neutral Al₂O₃ column followed by dialysis to generate bromo-functionalized polyacrylamide. Bromo-functionalized polyacrylamide (0.10 mmol, 1 eq.) and NaN₃ (0.50 mmol, 5 eq.) are dissolved in DMF (30 mL). The reaction mixture is stirred at 50° C. overnight, then diluted with ethyl acetate (150 mL). NaN₃ and DMF is extracted with DI H₂O (150 mL) for 3 times. The organic layer is dried over Na₂SO₄ and concentrated by rotary evaporator to generate azido-functionalized polyacrylamide.

The synthesis of azido-functionalized polymethacrylate side chains can be performed according to the following.

To a Schlenk flask with a magnetic stir bar, methacrylate (15 mmol, 300 eq.), anisole (1.6 mL), CuBr₂ (0.005 mmol, 0.1 eq.), 4,4′-di-5-nonyl-2,2′-bipyridine (dNbpy) (0.01 mmol, 0.2 eq.), and ethyl a-bromophenylacetate (EBPA) (0.05 mmol, 1 eq.) are added. The mixture is cooled to 0° C. and sparged with N₂ for 20 minutes. A Cu wire (d=1 mm, l=1 cm) is then added into the solution under N₂ protection and the mixture is sparged for another 5 minutes. The reaction is stirred at 35° C. for 20 hours and quenched by opening cap, adding THF, and stirred overnight. The polymer is purified by passing through a neutral Al₂O₃ column followed by precipitation in CH₃OH and hexane sequentially to generate bromo-functionalized polymethacrylate. To a Schlenk flask with a magnetic stir bar, acrylate (2 mmol, 100 eq.), MeCN (3.0 mL), CuBr₂ (0.01 mmol, 0.5 eq.), PMDETA (0.05 mmol, 2.5 eq.), and bromo-functionalized polymethacrylate (0.02 mmol, 1 eq.) are added. The mixture is degassed by three cycles of freeze-pump-thaw. CuBr (0.04 mmol, 2 eq.) is then added into the frozen solution and the flask is evacuated and refilled with N₂ for three times (last time refill after thawing). The reaction is stirred at 60° C. for 22.5 hours and quenched by opening cap, adding THF, and stirred overnight. The polymer is purified by passing through a neutral Al₂O₃ column and then a syringe filter, followed by precipitation in CH₃OH and hexane sequentially to generate bromo-functionalized polymethacrylate-block-polyacrylate. Bromo-functionalized polymethacrylate-block-polyacrylate (0.055 mmol, 1 eq.) and NaN₃ (0.277 mmol, 5 eq.) is added into DMF (20 mL) and stirred at 50° C. for 24 hours. The product is extracted with EtOAc (150 mL) and washed with water for three times. After dried over Na₂SO₄ and concentrated under reduced pressure, the polymer is redissolved in DCM (10 mL) followed by precipitation into cold hexanes (200 mL) to generate azido-functionalized polymethacrylate-block-polyacrylate with the majority as a polymethacrylate.

### Additional Example Commentary:

The above examples demonstrate that mGBCP compatibilizers have a great potential to be applied in the mechanical recycling of plastic waste, thanks to their extraordinary, unexpected and surprising performance as it relates to blend mechanical properties, low optimal concentration level in the blend, facile synthesis by click reaction, free of purification, and potentially expanded side chain library to accommodate different blends.

The success in HDPE/PS compatibilization as demonstrated by the above examples can be further refined with emphasis on the impact of structural parameters, e.g., side chain length, grafting density, blend composition, and processing conditions on the performance.

As described herein, the inventors of the present disclosure found that by adding at least about 0.2 wt. % to about 5.0 wt. %, more preferably from about 0.5 to about 3.0 wt. % of a mGBCP compatibilizer prepared by the methods described herein and containing polyethylene and polystyrene side chains to a blend of high density polyethylene and polystyrene, a high density polyethylene and polystyrene compatibilized blend was produced that exhibited an elongation at break and Young's modulus comparable to those of virgin high density polyethylene. By the method described herein, the system can be further expanded to blends further containing isotactic polypropylene, polydimethylsiloxane, poly(meth)acrylates, and/or poly(lactic acid), by varying the combination of side chains of the mGBCPs.

Different from GCPs, the microphase separation takes place between different side chains instead of backbone and side chain. As described herein, mGBCPs were synthesized via CuAAC click reaction between alkyne-pendant backbone and the two dissimilar side chains both end-monofunctionalized with an azido group. This grafting-to strategy starts with separately synthesized backbone and side chain precursors, therefore allowing a versatile combination of different grafts and precise synthesis of each structure component. The superior performance of the compatibilizers of the instant invention was revealed by a compatibilized blend that exhibited a high elongation at break of the blend, and a compatibilizer loading as low as 0.5 wt. %, a short side chain length compared to the block lengths in block copolymer and graft copolymer compatibilizers. In fact, the compatibilized polyethylene/polystyrene blend nearly restored the mechanical property of virgin high-density polyethylene.

In one aspect, the compatibilized blends exhibited extraordinary mechanical performance with a 100-fold increase of elongation at break compared to that of a pristine HDPE/PS blend, transforming brittle plastic blends to a tough and ductile material comparable with HDPE.

The low loading of the compatibilizers significantly reduces the cost in mechanical recycling of the plastic waste. High compatibilization efficiency eliminates the cost and labor needed in the sorting process. The compatibilized blends can be recycled multiple times with appropriate combination or addition of mGBCPs with different side chain composition.

Applicants have attempted to disclose all embodiments and applications of the disclosed subject matter that could be reasonably foreseen. However, there may be unforeseeable, insubstantial modifications that remain as equivalents. While the present invention has been described in conjunction with specific, exemplary embodiments thereof, it is evident that many alterations, modifications, and variations will be apparent to those skilled in the art in light of the foregoing description without departing from the spirit or scope of the present disclosure. Accordingly, the present disclosure is intended to embrace all such alterations, modifications, and variations of the above detailed description.

All patents, test procedures, and other documents cited herein, including priority documents, are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated.

1. A method of compatibilizing mixed plastic waste to produce a polymer blend that exhibits improved mechanical properties, the method comprising:
a) adding from about 0.05 to about 5 wt. % of a mixed-graft block copolymer compatibilizer to a blend of dissimilar polymers, wherein the mixed-graft block copolymer compatibilizer comprises: a linear polymeric backbone tethered to two or more types of polymeric side chains, wherein the two or more types of polymeric side chains are selected from the group consisting of polyethylene, polystyrene, isotactic polypropylene, atactic polypropylene, poly(methyl methacrylate), polyacrylate, polyacrylamide, polydimethylsiloxane, poly(lactic acid), poly(ethylene oxide), and polycaprolactone,
wherein the frequency of the two or more types of polymeric side chains tethered along the linear polymeric backbone ranges from about every 10 to about every 200 carbon atoms along the linear polymeric backbone; and
b) mixing the blend of dissimilar polymers and the mixed-graft block copolymer compatibilizer utilizing melt processing at a temperature greater than the melting points or glass transition temperatures of the dissimilar polymers, or utilizing solution processing for at least 30 minutes in the presence of a solvent at a temperature with the range of about 80 to about 150° C.;
wherein the polymeric side chains undergo phase separation in the blend of dissimilar polymers,
wherein each type of polymer side chain interacts with its corresponding homopolymer in the blend of dissimilar polymers by polymer chain entanglement and co-crystallization to produce a polymer blend exhibiting improved mechanical properties.

2. The method of claim 1, wherein the blend of dissimilar polymers comprise two or more of polyolefins, polystyrene, polar vinyl polymers, poly(lactic acid), poly(ethylene oxide), polycaprolactone, polydimethylsiloxane, or combinations thereof.

3. The method according to claim 1, wherein the solvent is selected from the group consisting of xylene, dichlorobenzene, trichlorobenzene, dimethylformamide, toluene, anisole, and benzene.

4. (canceled)

5. The method according to claim 1, wherein the compatibilized polymer blend exhibits at least a 100% increase in elongation at break as compared with a blend of the dissimilar polymers not including the mixed-graft block copolymer compatibilizer.

6. The method according to claim 1, wherein the compatibilized polymer blend exhibits at least a 100% increase in toughness as compared with a blend of the dissimilar polymers not including the mixed-graft block copolymer compatibilizer.

7. The method according to claim 1, wherein the frequency of the two or more types of polymeric side chains tethered along the linear polymeric backbone ranges from about every 20 to about every 50 carbon atoms along the linear polymeric backbone.

8. The method according to claim 1, wherein the compatibilized polymer blend exhibits an elongation at break ranging from about 20% to about 1000%.

9. The method according claim 1, wherein the mixed-graft block copolymer compatibilizer comprises two or more mixed-graft block copolymer compatibilizers and the two or more mixed-graft block copolymer compatibilizers are for compatibilizing a blend of isotactic polypropylene and high density polyethylene; a blend of polystyrene and poly(methyl methacrylate); a blend of polystyrene and high density polyethylene; a blend of polystyrene and isotactic polypropylene; a blend of isotactic polypropylene, high density polyethylene and polystyrene; a blend of isotactic polypropylene, high density polyethylene and polydimethylsiloxane; a blend of isotactic polypropylene, high density polyethylene, polystyrene and polydimethylsiloxane; or combinations thereof.

10. A mixed-graft block copolymer compatibilizer for compatibilizing a blend of dissimilar polymers, wherein the mixed-graft block copolymer compatibilizer comprises:
a linear polymeric backbone tethered to two or more types of polymeric side chains, wherein the two or more types of polymeric side chains are selected from the group consisting of polyethylene, polystyrene, isotactic polypropylene, atactic polypropylene, poly(methyl methacrylate), polyacrylate, polyacrylamide, polydimethylsiloxane, poly(lactic acid), poly(ethylene oxide), and polycaprolactone,
wherein the frequency of the two or more types of polymeric side chains tethered along the linear backbone ranges from about every 10 to about every 200 carbon atoms along the linear backbone; and
wherein the linear polymeric backbone is derived from an alkyne-functionalized backbone precursor selected from the group consisting of polymethacrylate, polyacrylate, polystyrene, polyester, polynorbornene, polydimethylsiloxane, polyacrylamide and combinations thereof, preferably wherein the linear backbone comprises an alkyne-functionalized polymethacrylate; and
wherein the alkyne-functionalized backbone precursor exhibits a polydispersity index of less than about 1.5.

11. The mixed-graft block copolymer compatibilizer according to claim 10, wherein the linear polymeric backbone has a molecular weight up to about 1,000,000 g/mol.

12. (canceled)

13. The mixed-graft block copolymer compatibilizer according to claim 10, wherein the alkyne-functionalized backbone precursor exhibits a polydispersity index of less than about 1.3.

14. The mixed-graft block copolymer compatibilizer according to claim 10, wherein the linear polymeric backbone precursor comprises between about 10 and about 5,000 alkyne repeat units.

15. The mixed-graft block copolymer compatibilizer according to claim 10, wherein the two or more types of polymeric side chains includes at least one of polyethylene and isotactic polypropylene.

16. The mixed-graft block copolymer compatibilizer according to claim 10, including two polymeric side chains having a ratio of the two polymeric side chains ranging from 99:1 to 1:99.

17. The mixed-graft block copolymer compatibilizer according to claim 10, wherein the molecular weight of each of the polymeric side chains is in the range of about 1,000 to about 30,000 g/mol.

18. (canceled)

19. (canceled)

20. (canceled)

21. A method of making a mixed-graft block copolymer compatibilizer for compatibilizing a blend of dissimilar polymers, the method comprising the steps of:
a) synthesizing a linear polymeric backbone including alkyne functional groups, preferably wherein the linear polymeric backbone comprises an alkyne-functionalized polymethacrylate backbone;
b) synthesizing a first azido-functionalized polymeric side chain precursor;
c) synthesizing a second azido-functionalized polymeric side chain precursor, wherein the polymer in the second azido-functionalized polymeric side chain precursor is different from the polymer in the first azido functionalized polymeric side chain precursor;
d) optionally, synthesizing one or more additional azido-functionalized polymeric side chain precursors, each of which contains a polymer that is different from the polymer in any of other azido-functionalized polymeric side chain precursors; and
e) synthesizing the multi-graft block copolymer compatibilizer by reacting the linear polymeric backbone including alkyne functional groups with the first azido-functionalized polymeric side chain precursor, the second azido-functionalized polymeric side chain precursor and the optional one or more additional azido-functionalized polymeric side chain precursors in the presence of a catalyst at temperature of between about 60 and about 100° C. to produce a mixed-graft block copolymer compatibilizer.

22. The method according to claim 21, wherein the catalyst is a copper catalyst comprising a reaction product of copper(I) halide complexes or copper(I) acetate and the reaction is a copper(I)-catalyzed azide-alkyne cycloaddition click reaction.

23. (canceled)

24. The method according to claim 21, wherein the alkyne-functionalized linear polymeric backbone precursor is selected from the group consisting of polymethacrylate, polyacrylate, polystyrene, polyester, polynorbornene, polydimethylsiloxane, polyacrylamide and combinations thereof.

25. The method according to claim 21, wherein the alkyne-functionalized linear polymeric backbone precursor exhibits a polydispersity index ranging from about 1.1 to about 2.0.

26. The method according to claim 21, wherein the alkyne-functionalized linear polymeric backbone precursor comprises between about 10 and about 5,000 alkyne repeat units.

27. The method according to claim 21, wherein the polymer of the first azido-functionalized polymeric side chain precursor, the second azido-functionalized polymeric side chain precursor, and the optional one or more additional azido-functionalized polymeric side chain precursors are selected from the group consisting of polyethylene, polystyrene, isotactic polypropylene, atactic polypropylene, poly(methyl methacrylate), polyacrylate, polyacrylamide, polydimethylsiloxane, poly(lactic acid), poly(ethylene oxide), and polycaprolactone.

28. The method according to claim 21, including two azido-functionalized polymeric side chains, wherein the ratio of the two azido-functionalized polymeric side chains is in the range of 99:1 to 1:99.

29. The method according to claim 21, wherein the molecular weight of each azido-functionalized polymeric side chain precursor is in the range of about 1,000 to about 30,000 g/mol.

30. (canceled)

31. (canceled)

32. The method according to claim 21, wherein the mixed-graft block copolymer compatibilizer includes a linear polymeric backbone tethered to two or more types of polymeric side chains, wherein the two or more types of polymeric side chains are selected from the group consisting of polyethylene, polystyrene, isotactic polypropylene, atactic polypropylene, poly(methyl methacrylate), polyacrylate, polyacrylamide, polydimethylsiloxane, poly(lactic acid), poly(ethylene oxide), and polycaprolactone.

33. The method according to claim 32, wherein the linear polymeric backbone of the mixed-graft block copolymer compatibilizer has a molecular weight up to about 1,000,000 g/mol.

34. The method according to claim 32, wherein the frequency of the two or more types of polymeric side chains tethered along the linear backbone ranges from about every 10 to about every 200 carbon atoms along the linear polymeric backbone.

35. The method according to claim 21 occurring in a solvent selected from the group consisting of xylene, dichlorobenzene, trichlorobenzene, dimethylformamide, toluene, anisole, and benzene.
